(19) United States
(12) Patent Application Publication
(10) Pub. No.: US 2009/0037445 A1
(43) Pub. Date: Feb. 5, 2009

(54) Information communication system, content catalog information distributing method, node device, and the like

(75) Inventor: Kentaro Ushiyama, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/232,597

(22) Filed: Sep. 19, 2008

Related U.S. Application Data
(63) Continuation-in-part of application No. PCT/JP2007/055475, filed on Mar. 19, 2007.

(30) Foreign Application Priority Data
Apr. 11, 2006 (JP) 2006-109158

(51) Int. Cl. G06F 15/16; G06F 17/30

(52) U.S. Cl. 707/100; 709/201; 707/E17.044

(57) ABSTRACT

A node device includes:
destination information storing means for storing destination information of representative node devices belonging to the groups;
content catalog information receiving means for receiving content catalog information transmitted from another node device, the content catalog information being one in which attribute information of content data which can be obtained by the information communication system is written;
content catalog information transmitting means, in the case where the group to which the node device itself belongs is further divided in a plurality of groups in accordance with the predetermined rule, for transmitting the received content catalog information to the representative node devices belonging to the groups in accordance with destination information of the representative node devices belonging to the groups further divided; and
content catalog information storing means for storing all or part of the received content catalog information.

### CROSS REFERENCE TO RELATED APPLICATIONS

The present application claims priority from Japanese Patent Application NO. 2006-109158, which was filed on Apr. 11, 2006, and the entire disclosure of the Japanese Patent Application including the specification, claims, drawings, and abstract is herein incorporated by reference in its entirety.

### BACKGROUND OF THE INVENTION

1. Technical Field

The present invention relates to a peer-to-peer (P2P) content distribution system having a plurality of node devices capable of performing communication with each other via a network. More particularly, the invention relates to the technical field of a content distribution system and the like in which a plurality of pieces of content data are stored so as to be spread to the plurality of node devices.

2. Background Art

In a content distribution system of this kind, each of node devices has content catalog information in which attribute information (for example, content name, genre, artist name, and the like) of content data dispersedly stored in a plurality of node devices is written. On the basis of the attribute information written in the content catalog information, the user can download desired content data. Such content catalog information is common information to be commonly used by a plurality of node devices. Generally, content catalog information is managed by a management server for managing all of content data stored on a content distribution system. In response to a request from a node device, the content catalog information is transmitted from the management server to the node device.

For example, patent document 1 discloses, as a management server of this kind, an index server existing at the top and managing all of content information in the content distribution management system.

On the other hand, as a method of using no management server, pure P2P distribution systems such as Gnutella, Freenet, Winny, and the like are also devised. In those systems, a content name or a keyword related to content is designated to retrieve the content, the location is specified, and the content is accessed. In the method, however, a list of all of content names cannot be obtained. Consequently, the user cannot choose desired content from the content list and access it.

### Patent Document 1: Japanese Unexamined Patent Application Publication No. 2002-318720

### DISCLOSURE OF INVENTION

### Problems to be Solved by the Invention

In the peer-to-peer content distribution system, the frequency of withdrawal of a node device (due to power disconnection or a failure in the node device, partial disconnection of a network, and the like) and participation of a node device is high. Moreover, the frequency of storing new content data (content data newly loaded on the system) and deleting the content data is high. Consequently, content catalog information as described above has to be updated frequently. To maintain the content catalog information always in the latest state, it is therefore considered that the management server as described above is necessary.

However, in the content distribution system in which the management server manages the content catalog information, as the number of node devices increases, for example, as the server load increases at the time of updating the content catalog information, the network load is concentrated in one place, and an unpreferable problem occurs such that distributable content catalog information is also limited. When the management server goes down (for example, due to a failure or the like), a problem also occurs such that the content catalog information cannot be updated.

The present invention has been achieved in view of the above points and an object of the invention is to provide an information communication system, a content catalog information distribution method, a node device, and the like, capable of holding latest content catalog information without placing a load on a specific management apparatus such as a management server.

### Means for Solving the Problems

In order to solve the above problems, one aspect of the invention relates to a node device included in an information communication system having a plurality of node devices capable of performing communication with each other via a network, the plurality of node devices being divided in a plurality of groups according to a predetermined rule,

the node device comprising:

destination information storing means for storing destination information of representative node devices belonging to the groups;

content catalog information receiving means for receiving content catalog information transmitted from another node device, the content catalog information in which attribute information of content data which can be obtained by the information communication system is written;

content catalog information transmitting means, in the case where the group to which the node device itself belongs is further divided in a plurality of groups in accordance with the predetermined rule, for transmitting the received content catalog information to the representative node devices belonging to the groups in accordance with destination information of the representative node devices belonging to the groups further divided; and

content catalog information storing means for storing all or part of the received content catalog information.

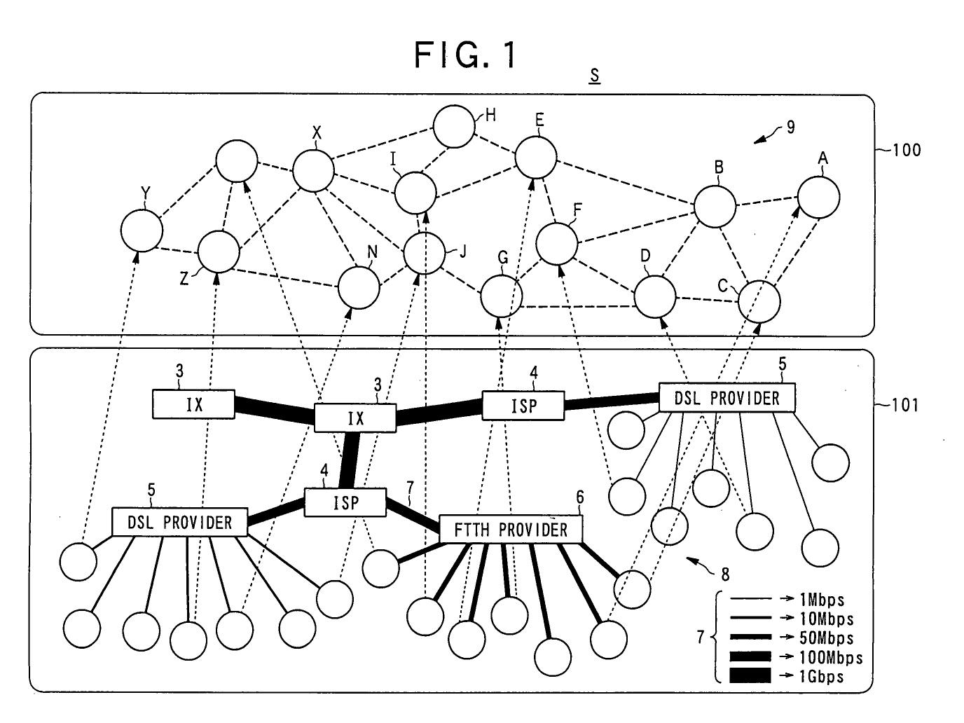

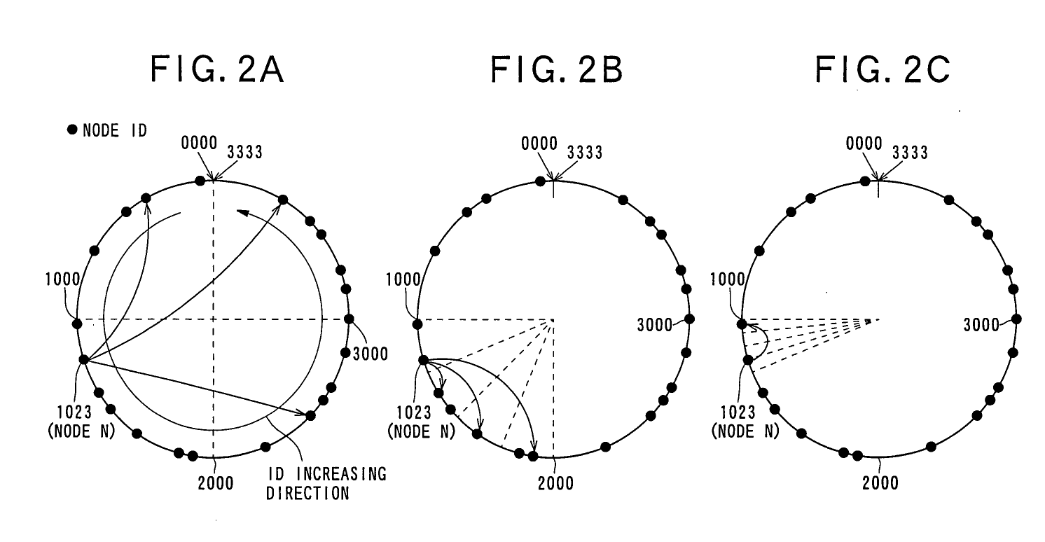

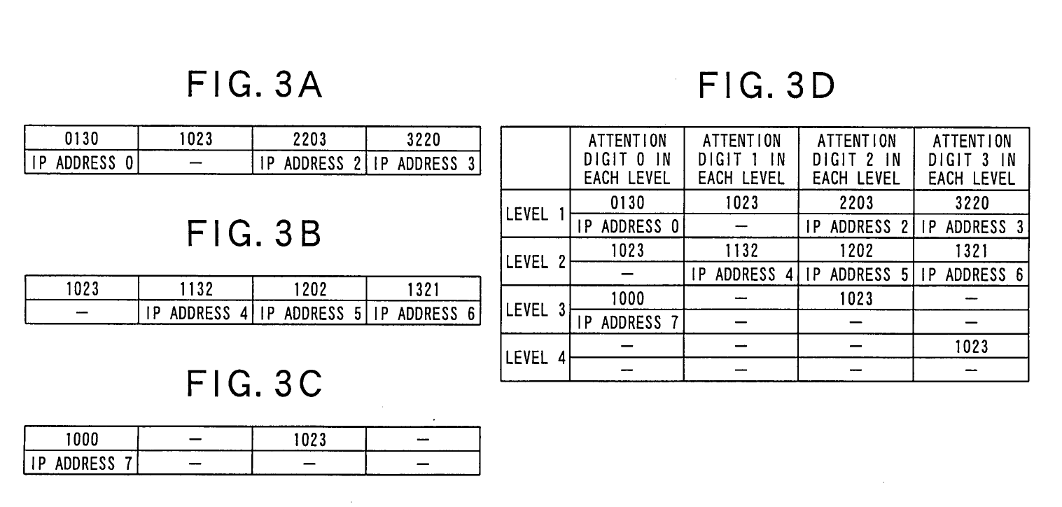

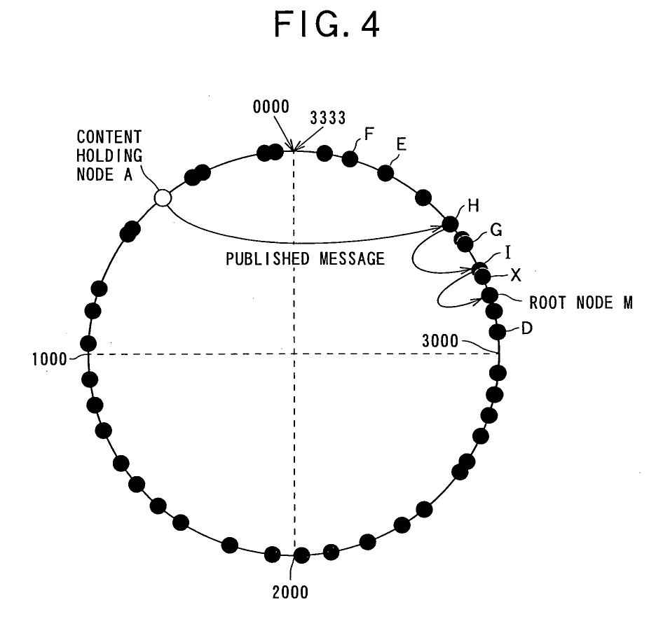

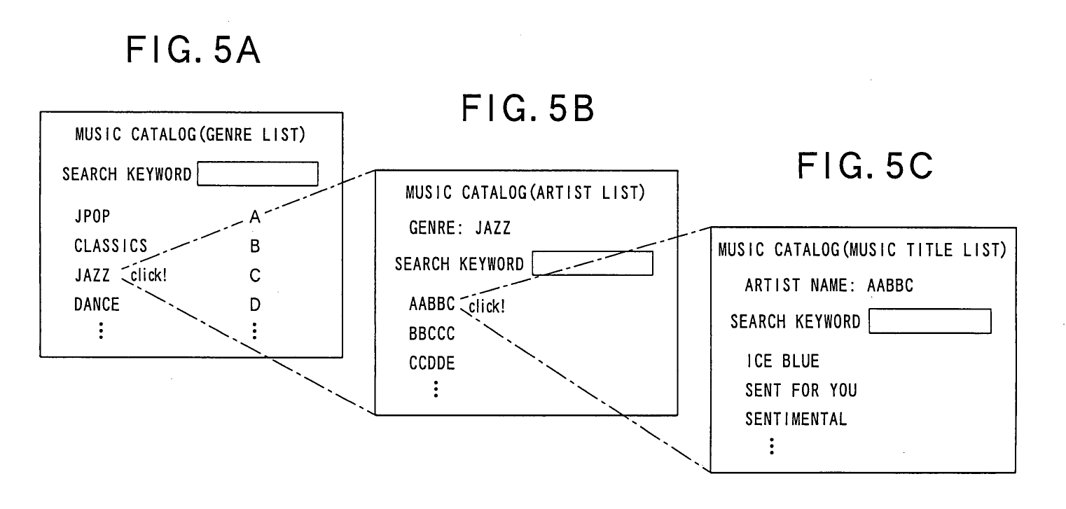

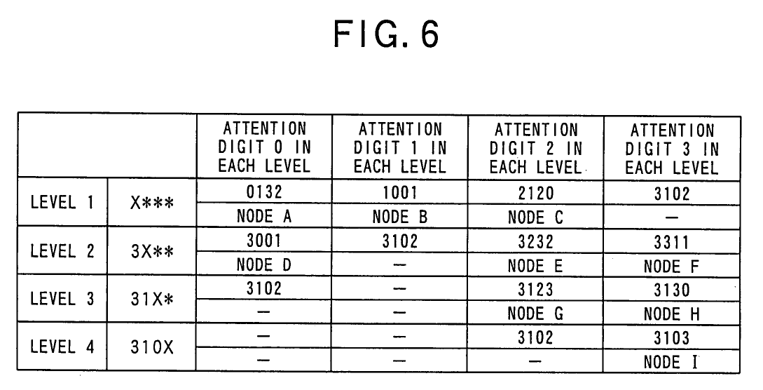

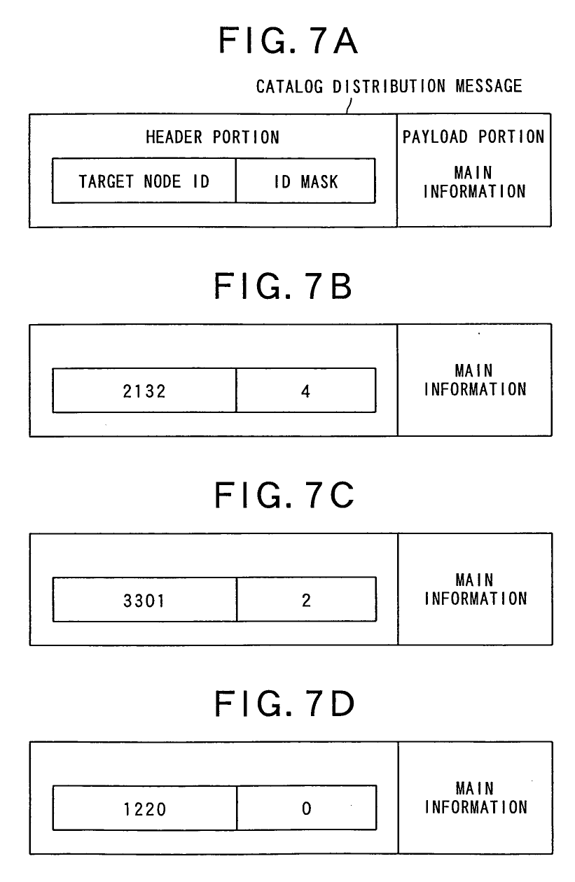

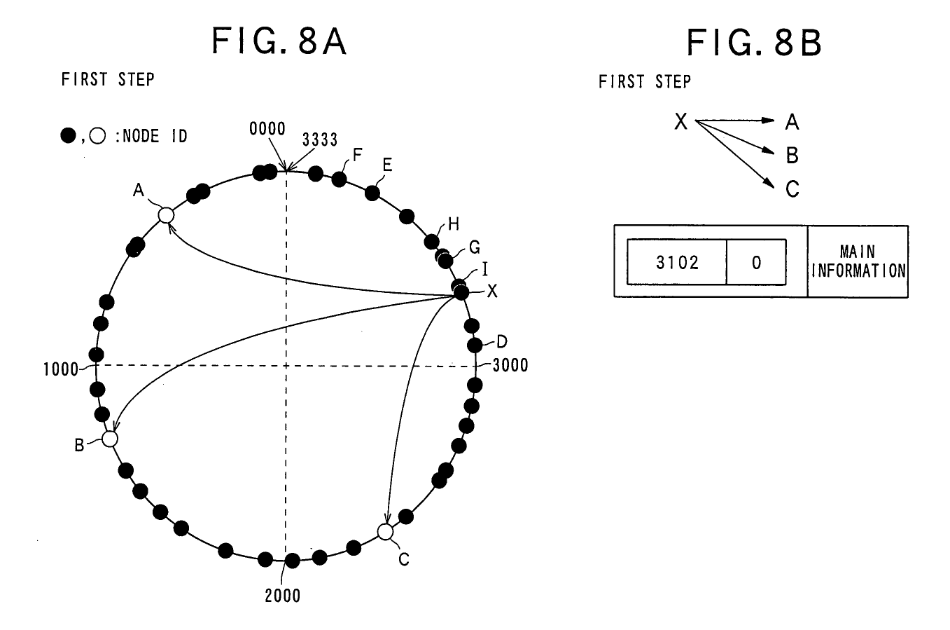

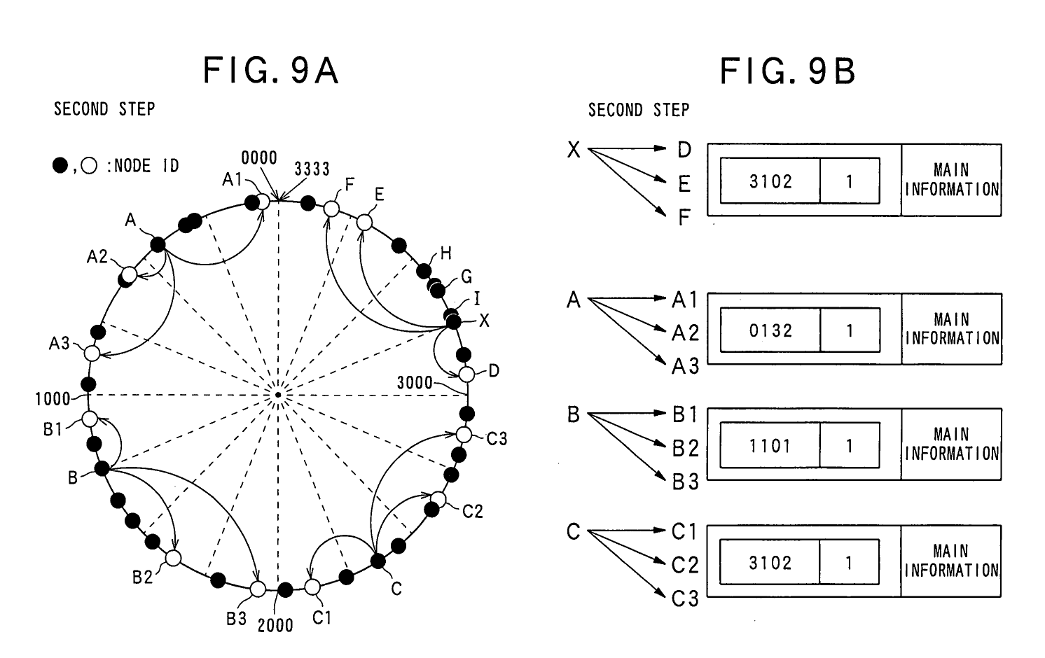

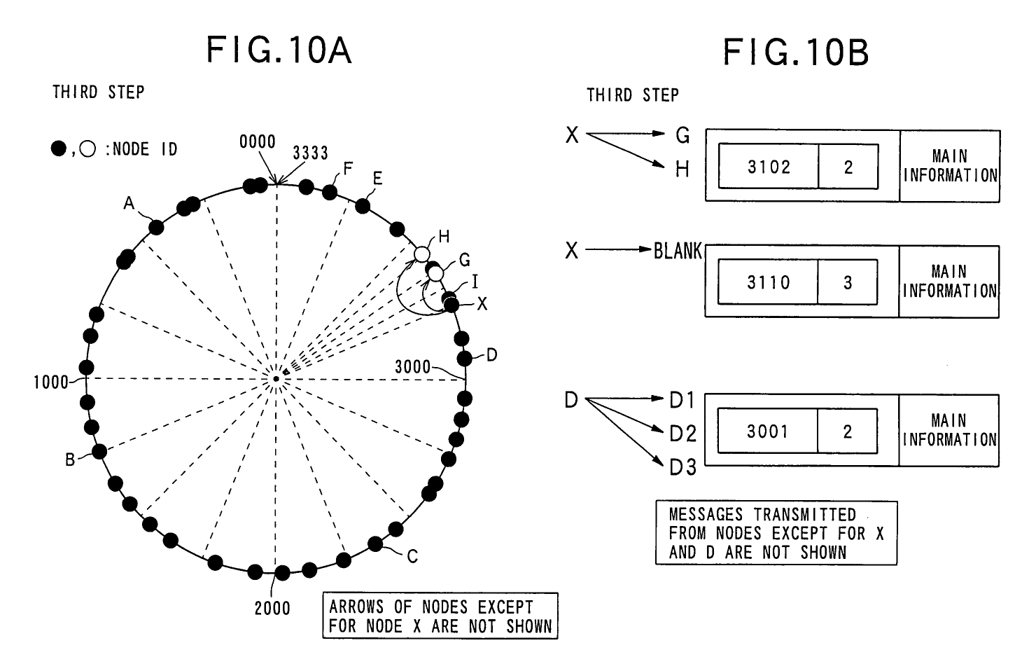

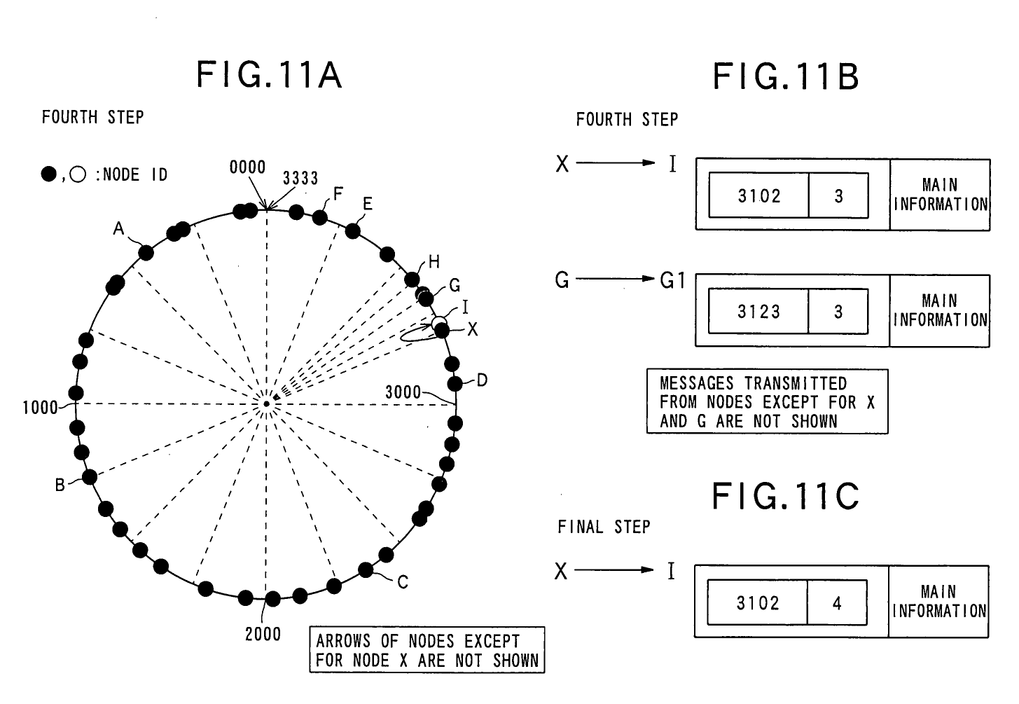

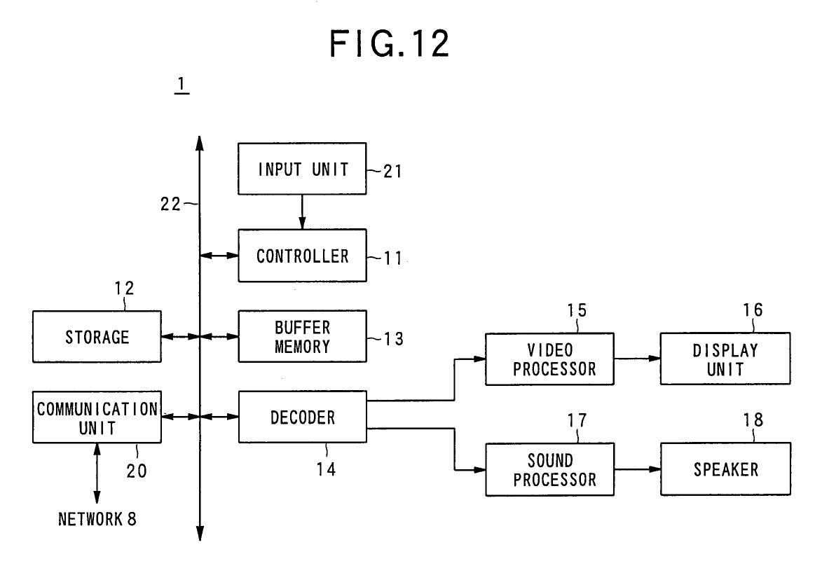

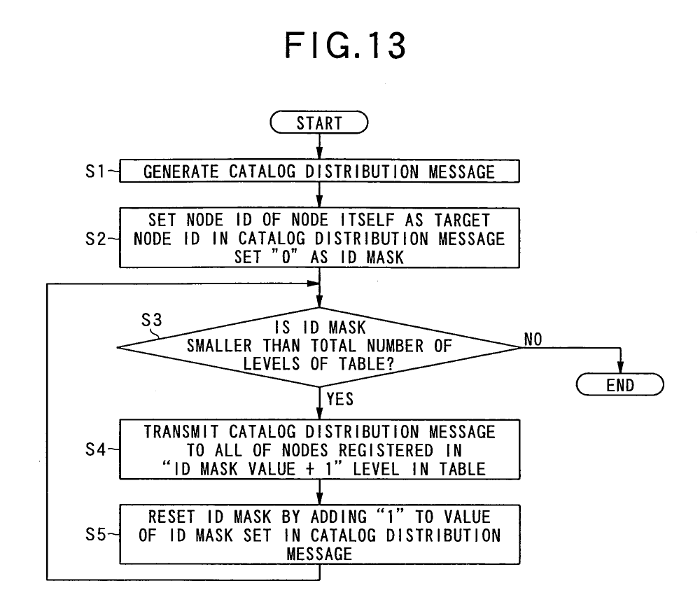

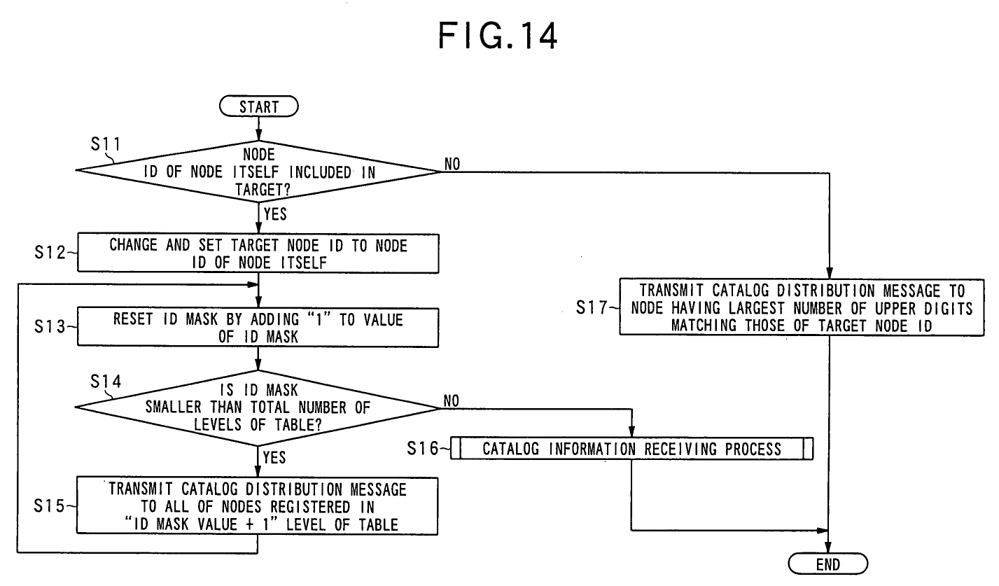

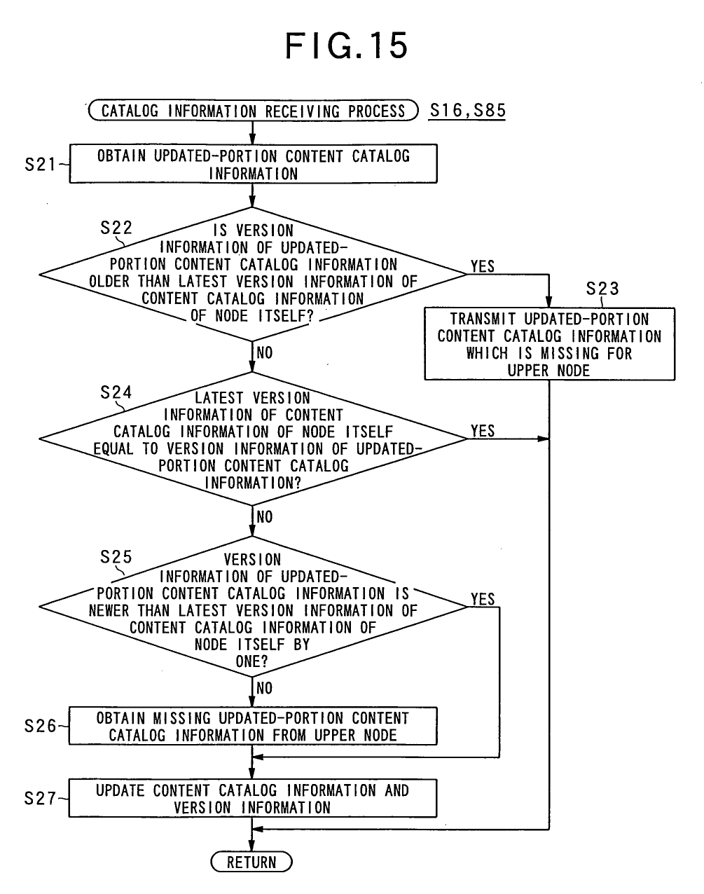

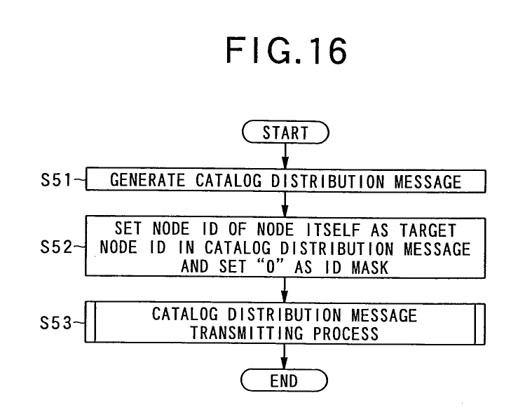

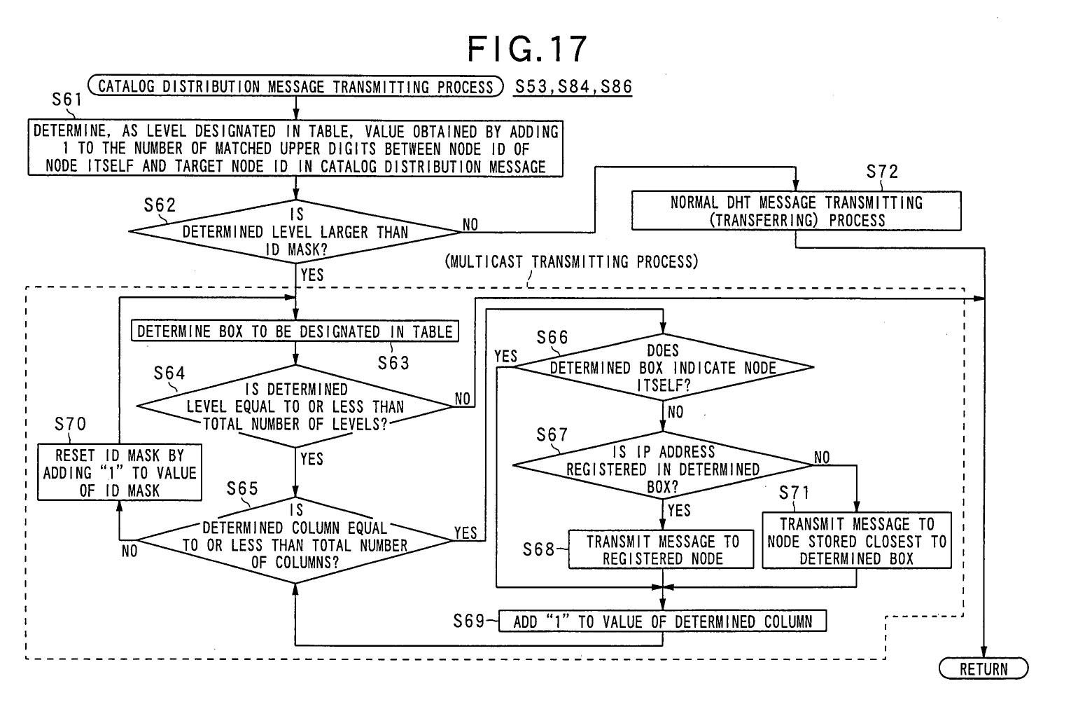

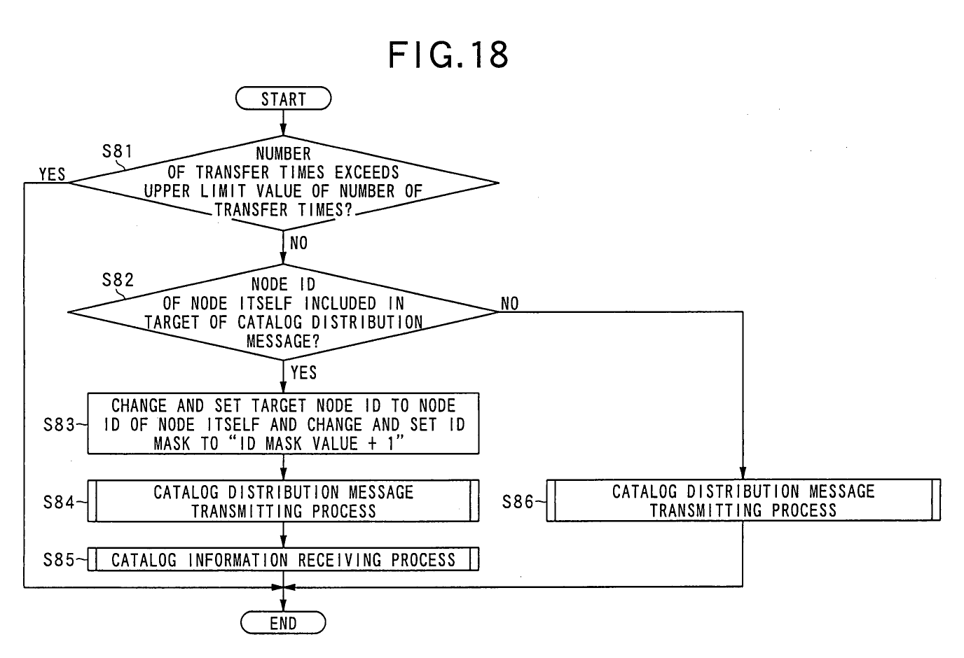

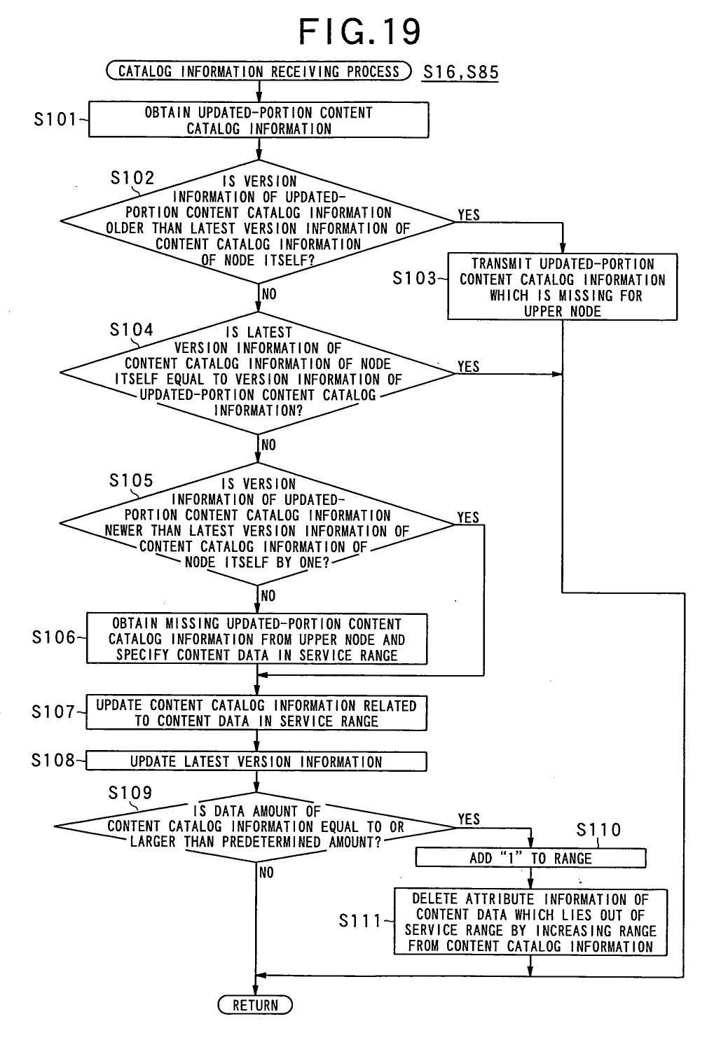

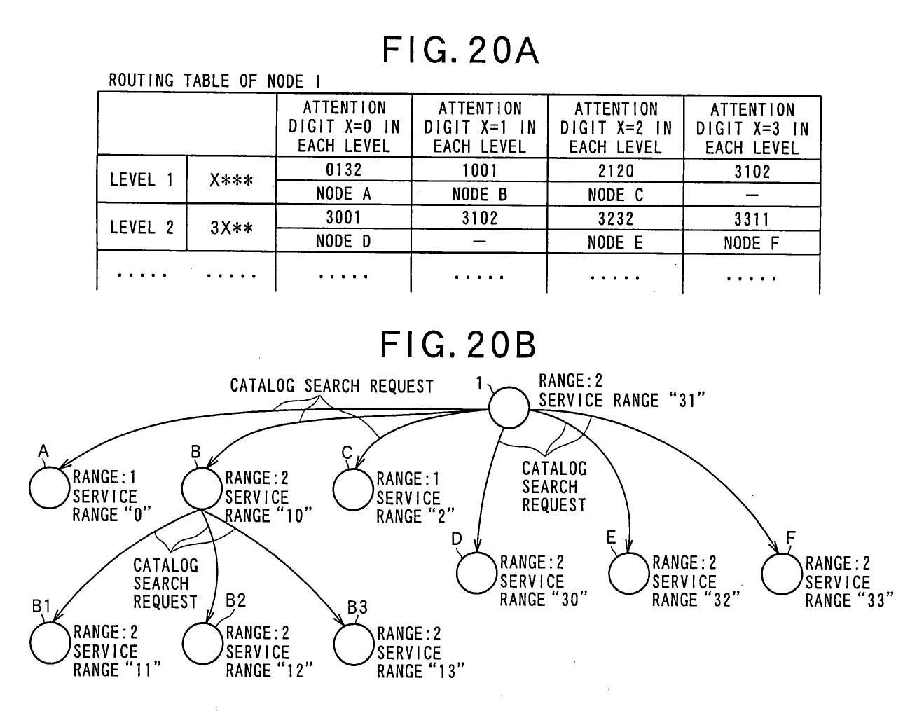

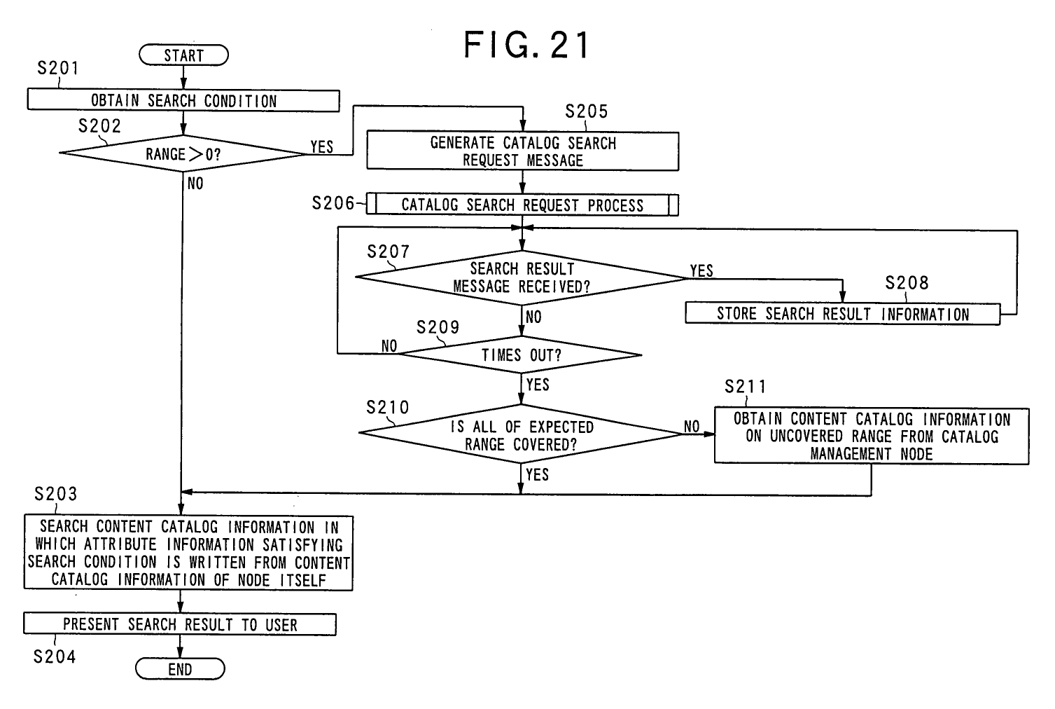

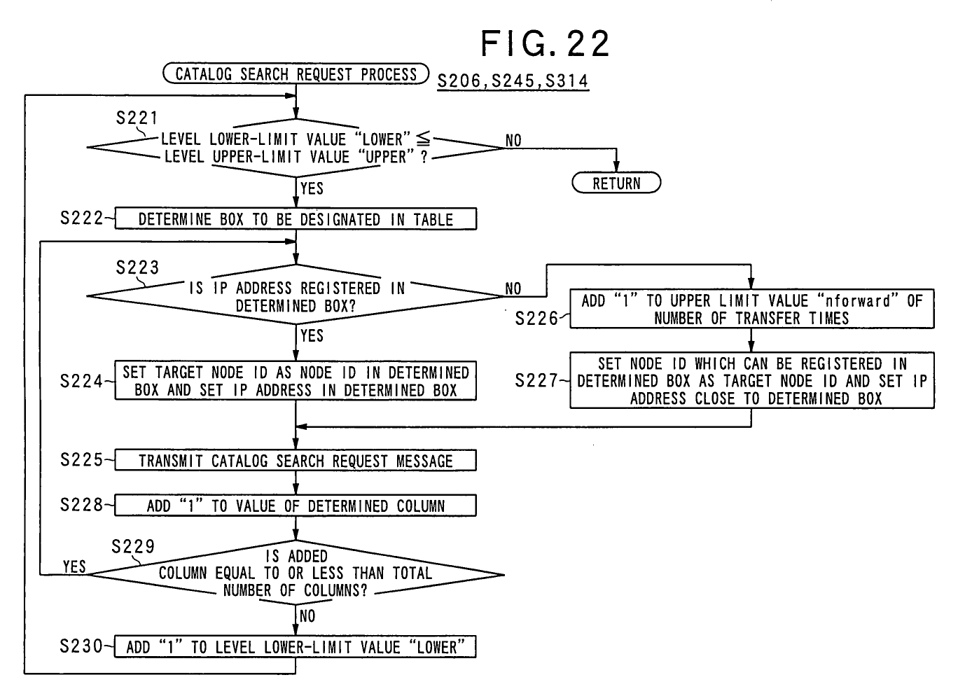

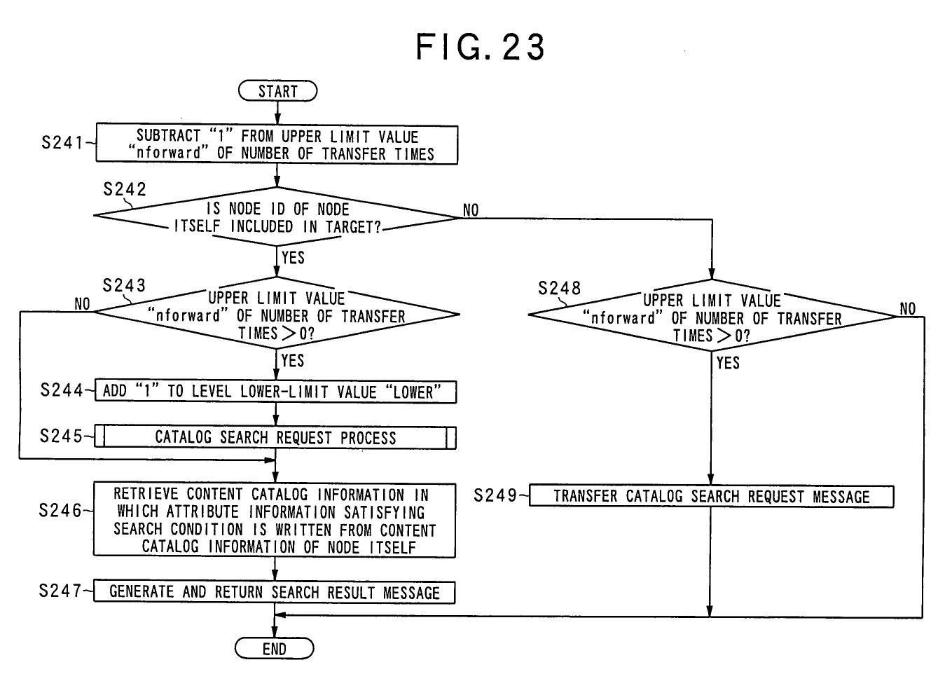

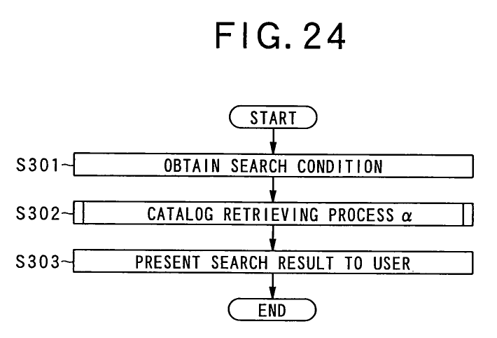

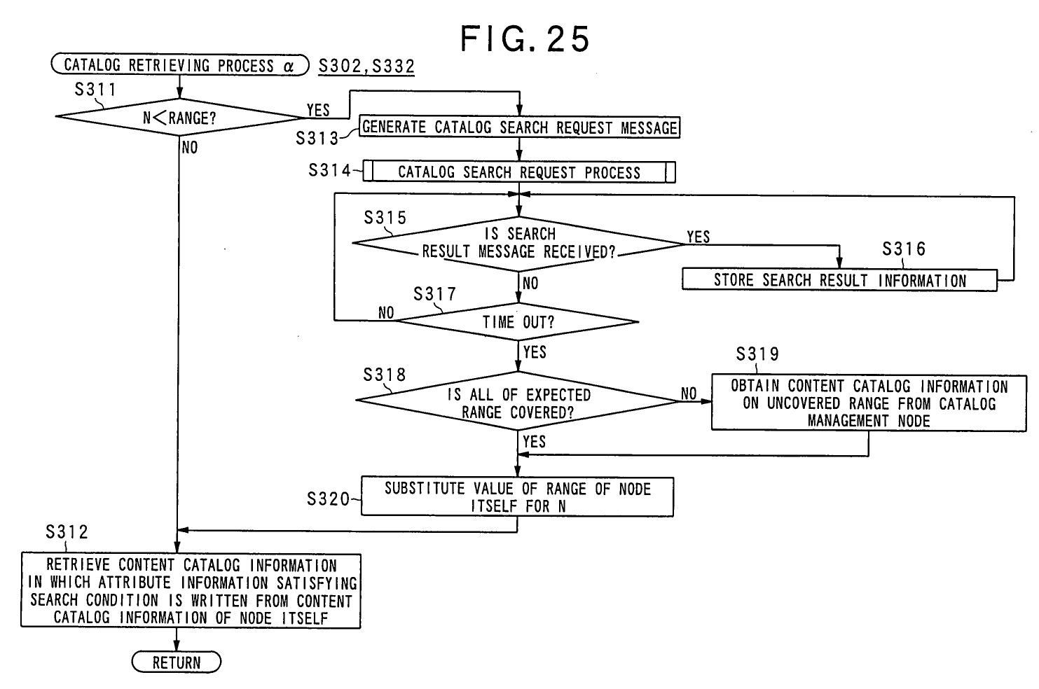

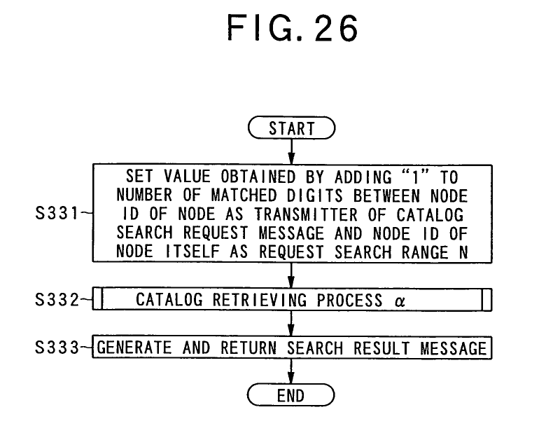

### BRIEF DESCRIPTION OF DRAWINGS

[FIG. 1] Diagram showing an example of a connection mode of each of node devices in a content distribution system as an embodiment.

[FIGS. 2A to 2C] Diagrams showing an example of a state where a routing table is generated.

[FIGS. 3A to 3D] Diagrams showing an example of the routing table.

[FIG. 4] Conceptual diagram showing an example of the flow of a published message transmitted from a content holding node, in a node ID space of a DHT.

[FIGS. 5A to 5C] Conceptual diagrams showing an example of display form transition of a music catalog.

[FIG. 6] An example of a routing table held in a node X as a catalog management node.

[FIGS. 7A to 7D] Diagrams schematically showing a catalog distribution message.

[FIGS. 8A and 8B] Diagrams showing a sate where a DHT multicast is performed.

[FIGS. 9A and 9B] Diagrams showing a state where a DHT multicast is performed.

[FIGS. 10A and 10B] Diagrams showing a state where a DHT multicast is performed.

[FIGS. 11A to 11C] Diagrams showing a state where a DHT multicast is performed.

[FIG. 12] Diagram showing a schematic configuration example of a node.

[FIG. 13] Flowchart showing DHT multicasting process in a catalog management node.

[FIG. 14] Flowchart showing process performed in a node which receives a catalog distribution message.

[FIG. 15] Flowchart showing the details of catalog information receiving process in FIG. 14.

[FIG. 16] Flowchart showing DHT multicasting process in the catalog management node.

[FIG. 17] Flowchart showing the DHT multicasting process in the catalog management node.

[FIG. 18] Flowchart showing process performed in a node which receives the catalog distribution message.

[FIG. 19] Flowchart showing the details of the catalog information receiving process.

[FIGS. 20A and 20B] FIG. 20A is a diagram showing an example of a routing table of a node I, and FIG. 20B is a conceptual diagram showing a state where a catalog retrieval request is sent from the node I.

[FIG. 21] Flowchart showing catalog retrieving process in a node.

[FIG. 22] Flowchart showing the details of catalog retrieval request process in FIG. 21.

[FIG. 23] Flowchart showing process in a node which receives a catalog retrieval request message.

[FIG. 24] Flowchart showing the catalog retrieving process in a node.

[FIG. 25] Flowchart showing catalog retrieving process a in a node.

[FIG. 26] Flowchart showing process in a node which receives a catalog retrieval request message.

### DESCRIPTION OF REFERENCE NUMERALS

A to Z node
8 network
9 overlay network
11 controller
7
12 storage
13 buffer memory.
14 decoder
15 video processor
16 display
17 sound processor
18 speaker
20 communication unit
21 input unit
22 bus
S content distribution system

### BEST MODE FOR CARRYING OUT THE INVENTION

A best mode for carrying out the present invention will be described with reference to the drawings. The following embodiment relates to the case of applying the present invention to a content distribution system using a DHT (Distributed Hash Table).

### 1. Configuration and the Like of Content Distribution System

First, a schematic configuration and the like of a content distribution system as an example of an information communication system will be described with reference to FIG. 1.

FIG. 1 is a diagram showing an example of a connection mode of node devices in a content distribution system as an embodiment.

As shown in a lower frame 101 in FIG. 1, a network (network in the real world) 8 such as the Internet is constructed by IXs (Internet eXchanges) 3, ISPs (Internet Service Providers) 4, apparatuses 5 of DSL (Digital Subscriber Line) providers, (an apparatus of) an FTTH (Fiber To The Home) provider 6, communication lines (for example, telephone lines, optical cables, and the like) 7, and so on. In the network (communication network) 8 in the example of FIG. 1, routers (not shown) for transferring a message (packet) are properly inserted.

A content distribution system S is constructed by having a plurality of node devices (hereinbelow, called “nodes”) A, B, C, . . . X, Y, Z . . . connected to each other via the network 8, thereby serving as a peer-to-peer network system. To each of nodes A, B, C, . . . , X, Y, Z . . . , unique serial number and a unique IP (Internet Protocol) address as destination information are assigned. The same serial number and the same IP address are not assigned to a plurality of nodes.

An algorithm using a distributed hash table (hereinbelow, called “DHT”) of the embodiment will be described below.

In the content distribution system S, to transmit/receive information to/from each other, the nodes have to know the IP addresses and the like of one another.

For example, in a system in which nodes share content, in a simple method, nodes participating in the network 8 know IP addresses of all of nodes participating in the network 8. However, when the number of terminals becomes a large number such as tens of thousands or hundreds of thousands, it is not realistic for each node to store IP addresses of all of the nodes. When the power source of an arbitrary node is turned on/off, a change in the IP address of the arbitrary node stored in each of the nodes is frequently updated so that it is difficult to update the change in operational viewpoint.

A system is devised such that a node remembers (stores) only the IP addresses of the minimum nodes out of all of nodes participating in the network 8 and receives information of the IP addresses of nodes the node do not remember (store) from other nodes.

As an example of such a system, an overlay network 9 as shown in an upper frame 100 in FIG. 1 is configured by an algorithm using a DHT. Specifically, the overlay network 9 denotes a network in which a virtual link formed by using the existing network 8 is constructed.

In the embodiment, the overlay network 9 constructed by the algorithm using the DHT is a precondition. A node disposed on the overlay network 9 will be called a node participating in the overlay network 9. A node which does not yet participate in the overlay network 9 participates in the overlay network 9 by sending a participation request to an arbitrary node already participating in the overlay network 9.

Each node has a node ID as unique node identification information. The node ID is a hash value of predetermined number of digits obtained by, for example, hashing an IP address or a serial number with a common hash function (for example, SHA-1 or the like). The node IDs are evenly spread and disposed in a single ID space. The number of bits of a node ID has to be large enough to accommodate the maximum number of operating nodes. For example, when the number of bits is 128, 2̂128=340×10̂36 nodes can be operated.

When the IP addresses or the serial numbers are different from each other, the probability that node IDs obtained with the common hash function have the same value is extremely low. Since the hash function is known, the details will not be described.

### 1.1 Method of Generating Routing Table of DHT

An example of a method of generating a routing table as a DHT will be described with reference to FIGS. 2A to 2C and FIGS. 3A to 3D.

FIGS. 2A to 2C are diagrams showing an example of a state where a routing table is generated, and FIGS. 3A to 3D are diagrams showing an example of a routing table.

Since node IDs assigned to nodes are generated with the common hash function, it can be considered that the node IDs exist so as to be spread on the same ring-shaped ID space not so unevenly as shown in FIGS. 2A to 2C. FIGS. 2A to 2C show a state where node IDs each made of eight bits are assigned. Solid circles in the diagrams indicate node IDs, and it is assumed that the number of IDs increases in a counterclockwise direction.

First, as shown in FIG. 2A, an ID space is divided into some areas as groups in accordance with a predetermined rule. In practice, an ID space is often divided into about 16 areas. For simplicity of explanation, the ID space is divided into four areas, and an ID is expressed in quaternary number of a bit length of eight bits. The node ID of the node N is set as “1023”, and an example of generating a routing table of the node device N will be described.

### Routing at Level 1

First, when an ID space is divided into four areas and each of the areas is expressed in quaternary number, the ID space is divided into four areas whose the largest digits are different from each other “0XXX”, “1XXX”, “2XXX”, and “3XXX” (X denotes an integer from b to 3, also in the following description). Since the node ID of the node N is “1023”, the node N exists in the left lower area “1XXX” in the diagram.

The node N selects an arbitrary node 1 existing in an area (belonging to a group) other than the area where it exists (that is, the area “1XXX”), and registers (stores) the IP address and the like (actually, port number is also included, also in the following description) of the node ID into boxes (table entries) in the table of level 1. FIG. 3A shows an example of the table at level 1. Since the second box in the table at level 1 denotes the node N itself, it is unnecessary to store the IP address and the like.

### Routing at Level 2

Next, as shown in FIG. 2B, the area where the node N exists in the four areas divided by the routing is further divided into four areas “10XX”, “11XX”, “12XX”, and “13XX” (that is, the group to which the node N itself belongs is further divided into a plurality of smaller groups).

In a manner similar to the above, a node existing in an area other than the area where the node N exists is properly selected as a representative node, and the IP address and the like of the node ID is stored in boxes (table entries) in the table of level 2. FIG. 3B shows an example of the table at level 2. Since the first box in the table of level 2 shows the node N itself, it is unnecessary to store the IP address and the like.

### Routing at Level 3

Further, as shown in FIG. 2C, the area where the node N exists in the four areas divided by the routing is further divided into four areas “100X”, “101X”, “102X”, and “103X” (that is, the small group to which the node N itself belongs is further divided into a plurality of smaller groups). In a manner similar to the above, arbitrary nodes existing in the areas other than the area where the node N exists are selected as representative nodes, and the IP address and the like of the node ID is stored into boxes (table entries) in the table of level 3. FIG. 3C shows an example of the table at level 3. Since the third box in the table of level 3 shows the node N itself, it is unnecessary to store the IP address and the like. Since no node exists in the areas in the second and fourth boxes, the second and fourth boxes are blank.

By generating routing tables similarly to level 4 as shown in FIG. 3D, all of IDs of eight bits can be covered. The higher the level is, the more the blanks are becoming conspicuous in the table.

Each of all of the nodes generates the routing table generated according to the above-described method (rule) and owns it (the routing table is generated when a not-participating node participates in the overlay network 9 but the details will not be described since it is not directly related to the present invention).

As described above, each of the nodes stores the IP address or the like as the destination information of another node and the areas in the node ID as a group and small groups, that is, the levels and boxes in the DHT so as to be associated with each other.

To be specific, each node stores a routing table. In the routing table, the IP address or the like of a node belonging to any of a plurality of areas divided is specified as a level in association with the area. The area where the node exists is further divided into a plurality of areas. The IP address or the like of a node belonging to any of the divided areas is specified as the next level.

The number of levels is determined according to the number of digits of a node ID, and the number of target digits in each level in FIG. 3D is determined according to the number of digits. Concretely, in the case of 16 digits and hexadecimal numeral, an ID is made of 64 bits and numerals (alpha-numerals) of the target digits at level 16 are 0 to F. In the description of the routing table to be given later, a part indicative of the numbers of the target digits at each of the levels will be also simply called a “box”.

### 1.2 Method of Storing and Finding Content Data

A method of storing and finding content data which can be obtained in the content distribution system S will now be described.

In the overlay network 9, various content (such as movies and music) is stored so as to be spread to nodes (in other words, content data is copied and replicas as copy information are dispersedly stored).

For example, content data of a movie whose title is XXX is stored in the nodes A and D. On the other hand, content data of a movie whose title is YYY is stored in the nodes B and C. In such a manner, content data is stored so as to be spread to a plurality of nodes (hereinbelow, called “content holding nodes”).

To content data, information such as the content name (title) and content ID (content identification information peculiar to the content) is added. The content ID is generated by, for example, hashing “content name+arbitrary numerical value (or a few bytes from the head of the content data)” with the same hash function as that used to obtain the node ID (the content ID is disposed in the same ID space as that of node IDs). Alternatively, the system administrator may give an unconditional ID number (having the same bit length as that of a node ID) to each of content. In this case, content catalog information to be described later in which the correspondence between a content name and a content ID is written is distributed to each of the nodes.

Index information is stored (in an index cache) and managed in a node managing the location of content data (hereinbelow, called “root node” or “root node of content (content ID)”) or the like. The index information includes a set of the location of content data dispersedly stored, that is, the IP address or the like of a node that stores the content data and a content ID corresponding to the content data.

For example, the index information of content data of a movie whose title is XXX is managed by a node M as the root node of the content (content ID). Index information of content data of a movie whose title is YYY is managed by the node O as the root node of the content (content ID).

That is, different root nodes are used for different content, so that the load is shared. Moreover, even in the case where the same content data (the same content ID) is stored in a plurality of content holding nodes, index information of the content data can be managed by a single root node. As such a root node, for example, a node having a node ID closest to the content ID (for example, having the largest number of upper digits matched) is determined.

A node that holds content data (content holding node) generates a publishing (registration notification) message including the content ID of the content data and the IP address of the node itself (a registration message of a request for registration of the IP address and the like since the content data is stored) in order to notify the root node of the storage of the content data. The content holding node transmits the publishing message to its root node. The publishing message reaches the root node by DHT routing using the content ID as a key.

FIG. 4 is a conceptual diagram showing an example of the flow of a publishing message transmitted from the content holding node in a node ID space of a DHT.

In the example of FIG. 4, for example, the node A as a content holding node obtains the IP address and the like of the node H having the node ID closest to the content ID included in a published message (for example, the node ID having the largest number of upper digits matched with those of the content ID) with reference to the table of the level 1 of the DHT of itself. The node A transmits the published message to the IP address and the like.

The node H receives the published message, with reference to the table of the level 2 of the DHT of itself, obtains, for example, the IP address and the like of the node I having the node ID closest to the content ID included in the published message (for example, the node ID having the largest number of upper digits matched with those of the content ID), and transfers the published message to the IP address and the like.

On the other hand, the node I receives the published message, with reference to the table of level 3 of the DHT of itself, obtains, for example, the IP address and the like included in transfer destination node information of the node M having the node ID closest to the content ID included in the published message (for example, the node ID having the largest number of upper digits matched with those of the content ID), and transfers the published message to the IP address and the like.

The node M receives the published message, with reference to the table of the level 4 of the DHT of itself, recognizes that the node is the node having the node ID closest to the content ID included in the published message (for example, the node ID having the largest number of upper digits matched with those of the content ID), that is, the node itself is the root node of the content ID, and registers the index information including the set of the IP address and the like included in the published message and the content ID (stores the index information into an index cache region).

The index information including the set of the IP address or the like included in the published message and the content ID is registered (cached) in nodes (hereinbelow, called “relay nodes” which are, in the example of FIG. 4, nodes H and I) existing in the transfer path extending from the content holding node to the root node (in the following, the relay node caching the index information will be called a cache node).

In the case where the user at a node wishes to obtain desired content data, the node desiring to obtain the content data (hereinbelow, called “user node”) transmits a content location inquiring message to another node in accordance with the routing table of itself. The message includes the content ID of the content data selected from the content catalog information by the user. Like the published message, the content location inquiring message is transferred via some relay nodes by the DHT routing using the content ID as a key and reaches the root node of the content ID. The user node obtains (receives) the index information of the content data from the root node, connects it to the content holding node that holds the content data on the basis of the IP address and the like, and can obtain (download) the content data. The user node can also obtain (receive) the IP address from the relay node (cache node) caching the same index information as that in the root node before the content location inquiring message reaches the root node.

### 1.3 Details of Content Catalog Information

Next, the details of content catalog information will be described.

In the content catalog information (also called content list), attribute information of a number of pieces of content data which can be obtained by nodes in the content distribution system S is written in association with the content IDs. Examples of the attribute information are content name (movie title in the case where content is a movie, music piece title in the case where content is a music piece, and program title in the case where content is a broadcasting program), a genre (action, horror movie, comedy movie, love story, and the like in the case where content is a movie; rock, jazz, pops, classic, and the like in the case where content is music; and drama, sports, news, movie, music, animation, variety show, and the like in the case where content is a broadcasting program), artist name (singer, group, and the like in the case where content is music), performer (cast in the case where content is a movie or broadcasting program), and director's name (in the case where content is a movie).

The attribute information is the elements in the case where the user specifies desired content data, and is also used as a search keyword as a search condition for retrieving desired content data from a number of pieces of content data. For example, when the user enters “jazz” as a search keyword, all of content data corresponding to “jazz” as attribute information is retrieved, and the attribute information of the retrieved content data (for example, the content name, genre, and the like) is presented selectably to the user.

FIGS. 5A to 5C are conceptual diagrams showing an example of display form transition of a music catalog. The music catalog is an example of content catalog information of the present invention. For example, when jazz is entered as a search keyword for a search from a list of genres displayed as shown in FIG. 5A, a list of artist names corresponding to the jazz is displayed as shown in FIG. 5B. For example, an artist “AABBC” is entered as a search keyword for a search from the list of artist names. A list of music piece titles corresponding to the artist (for example, titles of music pieces sang or played by the artist) is displayed as shown in FIG. 5C. When the user selects a desired music piece title via an input means from the list of music piece titles, the content ID of the music piece data (an example of content data) is obtained and, as described above, the content location inquiry message including the content ID is transmitted toward the root node. The content ID does not have to be written in the content catalog information. In this case, each of the nodes may generate a content ID by hashing “content name+arbitrary numerical value” included in the attribute information with the above-described common hash function which is also used for hashing a node ID.

Such content catalog information is managed by, for example, a node managed by the system administrator or the like (hereinbelow, called “catalog managing node”) or is managed by a catalog managing server. For example, content data newly entered onto the content distribution system S is permitted by the catalog managing node and is stored in a node on the content distribution system S (as described above, the content data once entered is obtained from the content holding node and a replica of the content data is stored). In the case where new content data is stored in a node on the content distribution system S, the attribute information of the content data is newly registered in the content catalog information (serial numbers are added in order of registration), thereby updating the content catalog information (version-upgrade). Also in the case where content data is deleted from the content distribution system S, when the deletion is permitted by the catalog managing node, the attribute information of the content data is deleted from the content catalog information, thereby updating the content catalog information (also in the case where the attribute information is partly changed, similarly, the content catalog information is updated).

Version information indicative of the version is added to the whole content catalog information. The version information is given with, for example, version serial numbers. Each time the content catalog information is updated (for example, each time the attribute information of content data is newly registered) the serial number is incremented by a predetermined value (for example, “1”) (content data may be newly registered in the content catalog information when a predetermined amount of content data to be registered is accumulated or each time a new registration request is received).

Further, for example, version serial numbers at the time of new registration are added to the content data (the version serial numbers are not counted up but unchanged even when the entire content catalog information is updated) (for example, version serial number “1” is added to content data of the serial number “100”, and version serial number “2” is added to content data of the serial number “200”). From the numbers, the versions of the content data can be determined.

### 1.4 Method of Distributing Content Catalog Information

Subsequently, a method of distributing content catalog information will be described with reference to FIG. 6 to FIGS. 11A and 11B.

Such content catalog information can be distributed to all of nodes participating in the overlay network 9 by, for example, multicast using the DHT (hereinbelow, called “DHT multicast”).

FIG. 6 shows an example of a routing table held by the node X as the catalog managing node. FIGS. 7A to 7D are diagrams schematically showing a catalog distribution message. FIGS. 8 to 11 are diagrams showing a state where the DHT multicast is performed.

It is assumed that the node X holds a routing table as shown in FIG. 6 and, in each of the boxes corresponding to the areas at levels 1 to 4 in the routing table, a node ID (four digits in quaternary number), the IP address, and the like of any of the nodes A to I is stored.

As shown in FIG. 7A, a catalog distribution message is a packet constructed by a header portion and a payload portion. The header portion includes target node ID, ID mask as a group specifying value indicative of the level, and the IP address and the like (not shown) of a node corresponding to the target node ID. The payload portion includes main information having a unique ID for identifying a message and content catalog information.

The relation between the target node ID and the ID mask will be described in detail.

The target node ID has the same number of digits as that of the node ID (in the example of FIG. 6, four digits in quaternary number) and is used to set a node as a target of transmission. According to the value of an ID mask, for example, the node ID of a node for transmitting or transferring a catalog distribution message or the node of a node as a transmission destination is set.

The ID mask is used to designate the number of significant figures of a target node ID. By the number of significant figures, a node ID having the same upper digits, of the number corresponding to the number of significant figures, as those of the target node ID is shown. Concretely, the ID mask (the value of the ID mask) is an integer in a range from zero to the maximum number of digits of the node ID. For example, when the node ID has four digits and quaternary number, the value of the ID mask is an integer of 0 to 4.

For example, as shown in FIG. 7B, when the target node ID is “2132” and the value of the ID mask is “4”, all of the “4” digits of the target ID are valid. Only the node having the node ID of “2132” is a transmission destination target of the catalog distribution message.

As shown in FIG. 7C, when the target node ID is “3301” and the value of the ID mask is “2”, all of nodes on the routing table, each having a target node ID whose upper two digits are valid (node ID is “33**”) and upper two digits are “33” (lower two digits may have any values) are targets to which the catalog distribution message is transmitted.

Further, as shown in FIG. 7D, in the case where the target node ID is “1220” and the value of the ID mask is “0”, the upper “zero” digit in the target node ID is valid. That is, all of the digits may be any values (consequently, the target node ID may have any values). All of the nodes on the routing table are targets to which the catalog distribution message is transmitted.

In the case where the node ID four digits and quaternary number, DHT multicast of the catalog distribution message transmitted from the node X as the catalog managing node is performed in first to fourth steps as shown in FIGS. 8A and 8B to FIGS. 11A and 11B.

### First Step

The node X generates a catalog distribution message including a header portion and a payload portion using the target node ID in the header portion as the node ID “3102” of the node X itself (the node itself) and setting “0” as the ID mask. As shown in FIGS. 7A and 7B, the node X refers to the routing table shown in FIG. 6 and transmits the catalog distribution message to representative nodes (nodes A, B, and C) registered in the boxes in the table of level “1” obtained by adding “1” to the ID mask “0” (that is, the nodes belonging to different areas as groups).

### Second Step

The node X generates a catalog distribution message obtained by converting the ID mask “0” to “1” in the header portion in the catalog distribution message. Since the target node ID is the node ID of itself, it is not changed. The node X refers to the routing table shown in FIG. 6 and transmits the catalog distribution message to nodes (nodes D, E, and F) registered in the boxes in the table of level “2” obtained by adding “1” to the ID mask “1” as shown in the upper right area in the space of the node IDs in FIG. 9A and FIG. 9B.

The node A which received the catalog distribution message (the catalog distribution message to the area to which the node itself belongs) from the node X in the first step generates a catalog distribution message obtained by changing the ID mask “0” in the header portion in the catalog distribution message to “1” and changing the target node ID “3102” to the node ID “0132” of itself. The node A refers to a not-shown routing table of itself and transmits the catalog distribution message to nodes (nodes A1, A2, and A3) registered in the boxes in the table of the level “2” obtained by adding “1” to the ID mask “1” as shown in the upper left area in the node ID space of FIG. 9A and FIG. 9B. That is, in the case where the area “0XXX” to which the node A belongs is further divided into a plurality of areas (“00XX”, “01XX”, “02XX”, and “03XX”), the node A determines (representative) nodes belonging to the further divided areas (nodes A1, A2, and A3), and transmits the received catalog distribution message to all of the determined nodes (nodes A1, A2, and A3) (in the following, operation is performed similarly).

Similarly, as shown in the lower left area and the lower right area in FIG. 9A and FIG. 9B, in the first step, the nodes B and C which receive the catalog distribution message from the node X also refer to the routing tables of themselves and generate and transmit a catalog distribution message obtained by setting the ID mask “1” for the nodes (nodes B1, B2, B3, C1, C2, and C3) registered in the boxes in the table of level 2 and setting the node ID of itself as the target node ID.

### Third Step

The node X generates the catalog distribution message obtained by changing the ID mask “1” to “2” in the header portion of the catalog distribution message. In a manner similar to the above, the target node ID is not changed. The node X refers to the routing table shown in FIG. 6 and transmits the catalog distribution message to nodes (nodes G and H) registered in the boxes in the table of level “3” obtained by adding “1” to the ID mask “2” as shown in the upper right area in the node ID space of FIG. 10A and FIG. 10B.

The node D which received the catalog distribution message from the node X in step 2 generates a catalog distribution message obtained by changing the ID mask “1” in the header portion of the catalog distribution message to “2” and converting the target node ID “3102” to the node ID “3001” of the node D itself. The node D refers to the routing table of the node itself and, as shown in FIG. 10B, transmits the catalog distribution message to the nodes (nodes D1, D2, and D3) registered in the boxes in the table of level “3” obtained by adding “1” to the ID mask “2”.

Similarly, although not shown, in the second step, each of the nodes E, F, A1, A2, A3, B1, B2, B3, C1, C2, and C3 which receive the catalog distribution message generates and transmits a catalog distribution message obtained by setting “2” to the ID mask and setting the node ID of itself as the target node ID to nodes (not shown) registered in the boxes in the table of level 3 with reference to the routing table of the node itself.

### Fourth Step

Next, the node X generates a catalog distribution message by changing the ID mask “2” in the header portion of the catalog distribution message to “3”. In a manner similar to the above, the target node ID is not changed. The node X refers to the routing table shown in FIG. 6 and transmits the catalog distribution message to the node I registered in the boxes in the table of level “4” obtained by adding “1” to the ID mask “3” as shown in the upper right area in the node ID space in FIG. 11A and FIG. 11B.

The node G which received the catalog distribution message from the node X in the third step generates a catalog distribution message obtained by changing the ID mask “2” in the header portion in the catalog distribution message to “3” and changing the target node ID “3102” to the node ID “3123” of the node ID of itself. The node G refers to the routing table of itself and transmits the catalog distribution message to the node G1 registered in the boxes in the table of the level “4” obtained by adding “1” to the ID mask “3” as shown in FIG. 11B.

Similarly, although not shown, each of nodes which received the catalog distribution message in the third step also refers to the routing table of itself, and generates and transmits a catalog distribution message obtained by setting the ID mask to “3” and using the node ID of itself as a target node ID for the nodes registered in the boxes in the table of level 4.

### Final Step

Finally, the node X generates the catalog distribution message obtained by changing the ID mask “3” to “4” in the header portion of the catalog distribution message. The node X recognizes that the catalog distribution message is addressed to itself (the node X itself) from the target node ID and the ID mask, and finishes the transmitting process.

On the other hand, in the fourth step, each of the nodes 1 which received the catalog distribution message also generates a catalog distribution message obtained by changing the ID mask “3” in the header portion in the catalog distribution message to “4”. From the target node ID and the ID mask, the node recognizes that the catalog distribution message is addressed to itself (the node itself) and finishes the transmitting process.

The unique ID included in the payload portion in the catalog distribution message is an ID assigned peculiarly to each catalog distribution message. The ID is unchanged for the entire period in which, for example, a message transmitted from the node X is transferred and reaches the final node. In the case where a replay message is sent back from each of the nodes in accordance with the catalog distribution message, the same unique ID as that of the original catalog distribution message is assigned.

As described above, the content catalog information is distributed from the node X as the catalog managing node to all of nodes participating in the overlay network 9 by the DHT multicast. Each of the nodes stores the content catalog information.

Also in the case where the content catalog information is updated, each time the information is updated, the information is distributed from the node X as the catalog managing node to all of nodes participating in the overlay network 9 by the DHT multicast. In this case, the content catalog information in which the attribute information of content data of the updated portion in the entire content catalog information (hereinbelow, called “updated-portion content catalog information”) is written is transmitted from the node X. The distributed updated-portion content catalog information is assembled in (added to) the content catalog information already stored in each of the nodes.

The “attribute information of content data of the updated portion in the entire content catalog information” denotes, for example, attribute information of content data which is newly registered, deleted, or changed in the content catalog information. By transmitting only the updated-portion content catalog information by the DHT multicast, the amount of data transmitted/received is decreased, and the load on the network 8 and process load in each of the nodes can be reduced.

In the content distribution system S, the frequency of withdrawal of a node from the overlay network 9 (due to power disconnection or a failure in the node, partial disconnection of a network, and the like) and participation of a node to the overlay network 9 (for example, by power-on) is high. Consequently, all of the nodes do not always have (store) the latest content catalog information (of version information of the latest version).

Specifically, a node withdrawn when the updated-portion content catalog information is distributed by the DHT multicast cannot receive the updated-portion content catalog information at that time. Therefore, the content catalog information held after participation in the overlay network 9 after that is old.

Therefore, in the embodiment, a node that receives updated-portion content catalog information distributed by the DHT multicast compares version information added to the updated-portion content catalog information with version information added to content catalog information which is already stored. On the basis of the comparison result, process is performed so that the content catalog information in all of the nodes participating in the overlay network 9 becomes the latest. The details of the process will be described later.

### 2. Configuration and the Like of Node

The configuration and function of the node will be described with reference to FIG. 12.

FIG. 12 is a diagram showing a schematic configuration example of the node.

As shown in FIG. 12, each node includes: a controller 11 as a computer constructed by a CPU having a computing function, a work RAM, a ROM for storing various data and programs, and the like; a storage 12 as destination information storing means, content catalog information storing means, and range information storing means constructed by an HD or the like for storing content data, content catalog information, a routing table, various programs, and the like; a buffer memory 13 for temporarily storing received content data and the like; a decoder 14 for decoding (decompressing, decrypting, or the like) encoded video data (video information) and audio data (sound information) and the like included in the content data; a video processor 15 for performing a predetermined drawing process on the decoded video data and the like and outputting the resultant data as a video signal; a display unit 16 such as a CRT or a liquid crystal display for displaying a video image on the basis of the video signal output from the video processor 15; a sound processor 17 for digital-to-analog (D/A) converting the decoded audio data to an analog audio signal, amplifying the analog audio signal by an amplifier, and outputting the amplified signal; a speaker 18 for outputting the audio signal output from the sound processor 17 as sound waves; a communication unit 20 for performing communication control on information to/from another node 1 via the network 8; and an input unit (such as a keyboard, a mouse, and an operation panel) 21 for receiving an instruction from the user and supplying an instruction signal according to the instruction to the controller 11. The controller 11, the storage 12, the buffer memory 13, the decoder 14, and the communication unit 20 are connected to each other via a bus 22. As a node, a personal computer, an STB (Set Top Box), a TV receiver, or the like can be applied.

By executing various programs (including a node processing program) stored on the storage 12 or the like by the CPU, the controller 11 controls the whole node in a centralized manner, and functions as the content catalog information receiving means, content catalog information transmitting means, version comparing means, updating means, content specifying means, service range changing means, catalog information deleting means, and the like, and performs processes which will be described later.

As a catalog cache area for storing content catalog information, a few KB (kilobytes) to a few MB (megabytes) in the storage area of the storage 12 are assigned. Such content catalog information may be pre-stored, for example, at the time of manufacture of a node or at the time of sales or distributed by DHT multicast and stored later.

The node process program may be, for example, downloaded from a predetermined server on the network 8. Alternatively, the program may be recorded on a recording medium such as a CD-ROM and read via a drive of the recording medium.

### 3. Operation of Content Distribution System

### 3.1 First Embodiment

First, the operation of the content distribution system S in a first embodiment will be described with reference to FIGS. 13 to 15.

The first embodiment relates to a mode of storing whole content catalog information in each of nodes.

FIG. 13 is a flowchart showing a DHT multicast process in the catalog managing node. FIG. 14 is a flowchart showing processes performed in a node which receives a catalog distribution message. FIG. 15 is a flowchart showing the details of a catalog information receiving process in FIG. 14.

It is assumed that each of nodes participating in the overlay network 9 operates (that is, the power is on and various settings are initialized) and waits for an instruction from the user via the input unit 21 and for reception of a message via the network 8 from another node.

It is also assumed that the content catalog information is already stored in nodes participating in the overlay network 9.

The process shown in FIG. 13 starts, for example, in the case where content catalog information is updated (also called “version upgrade”, the content catalog information may be updated generally or partly) in the node X as the catalog managing node. The controller 11 of the node X obtains a peculiar, unique ID and the updated-portion content catalog information, and generates a catalog distribution message including the obtained unique ID and the updated-portion content catalog information in the payload portion (step S1).

Subsequently, the controller 11 of the node X sets the node ID “3102” of itself as a target node ID in the header portion of the generated catalog distribution message, sets “0” as the ID mask, and sets the IP address of itself as the IP address (step S2).

The controller 11 discriminates (determines) whether the value of the ID mask set is smaller than the total number of levels (“4” in the example of FIG. 6) in the routing table of itself or not (step S3).

Since “0” is set in the ID mask, the value is smaller than the total number of levels in the routing table. Consequently, the controller 11 determines that the value of the ID mask is smaller than the total number of levels in the routing table (YES in step S3), determines all of the nodes registered at the level of “the set ID mask+1” in the routing table of itself (that is, since the area to which the node X belongs is further divided into a plurality of areas, a node belonging to each of the further divided areas is determined), and transmits the generated catalog distribution message to the determined node (step S4).

In the example of FIG. 6, the catalog distribution message is transmitted to the nodes A, B, and C registered at the level 1 as “ID mask “0”+1”.

The controller 11 resets the ID mask by adding “1” to the value of the ID mask set in the header portion in the catalog distribution message (step S5), and returns to step S3.

After that, the controller 11 similarly repeats the processes in the steps S3 to S5 with respect to the ID masks “1”, “2”, and “3”. The catalog distribution message is transmitted to all of nodes registered in the routing table of itself.

On the other hand, when it is determined in step S3 that the value of the ID mask is not smaller than the total number of levels of the routing table of the node itself (in the example of FIG. 6, when the value of the ID mask is “4”), the process is finished.

The node which receives the catalog distribution message transmitted temporarily stores the catalog distribution message and starts the process shown in FIG. 14. The node A will be described as an example.

When the process shown in FIG. 14 starts, the controller 11 of the node A determines whether or not the node ID of the node A itself is included in a target specified by the target node ID and the ID mask in the header portion of the received catalog distribution message (step S11).

The target node ID of the target is a node ID whose upper digit corresponds to the value of the ID mask. For example, when the ID mask is “0”, all of node IDs are included in the target. When the ID mask is “2” and the target node ID is “3102”, node IDs “31**” whose upper “two” digits are “31” (** may be any values) are included in the target.

Since the ID mask in the header portion of the catalog distribution message received by the node A is “0” and the number of significant figures is not designated, the controller 11 of the node A determines that the node ID “0132” of the node itself is included in the target (YES in step S11), and changes and sets the target node ID in the header portion of the catalog distribution message to the node ID “0132” of the node itself (step S12).

Subsequently, the controller 11 resets the ID mask by adding “1” to the value of the ID mask in the header portion of the catalog distribution message (in this case, a change from “0” to “1” (by changing the ID mask indicative a certain level to the ID mask indicative of the next level)) (step S13).

After that, the controller 11 determines whether or not the value of the reset ID mask is smaller than the total number of levels of the routing table of the node itself (step S14).

Since “1” is set in the ID mask and it is smaller than the total number of levels in the routing table, the controller 11 determines that the ID mask is smaller than the total number of levels in the routing table (YES in step S14), determines all of nodes registered at the level of “the reset ID mask+1” in the routing table of the node itself (that is, since the area to which the node A belongs is further divided in a plurality of areas, a node belonging to each of the further divided areas is determined), transmits the generated catalog distribution message to the determined nodes (step S15) and returns to step S13.

For example, the catalog distribution message is transmitted to the nodes A1, A2, and A3 registered at the level 2 as “ID mask “1”+1”.

After that, the controller 11 similarly repeats the processes in the steps S14 and S15 for the ID masks “2” and “3”. In such a manner, the catalog distribution message is transmitted to all of the nodes registered in the routing table of the node itself.

On the other hand, when the controller 11 determines in the step S11 that the node ID of the node itself is not included in the target specified by the target node ID and the ID mask in the header portion in the received catalog distribution message (NO in step S11), the controller 11 transmits (transfers) the received catalog distribution message to a node having the largest number of upper digits matched with the target node ID in the routing table (step S17), and finishes the process.

For example, when the ID mask is “2” and the target node ID is “3102”, it is determined that the node ID “0132” of the node A is not included in the target “31**”. The transfer process in step S17 is transfer of a message using a normal DHT routing table.

On the other hand, in the case where the controller 11 determines in the step S14 that the value of the ID mask is not smaller than the total number of levels in the routing table of the node (NO in step S14), the controller 11 starts catalog information receiving process (step S16). The catalog information receiving process is also performed in each of the nodes which received the catalog distribution message.

In the catalog information receiving process, as shown in FIG. 15, the controller 11 of the node which received the catalog distribution message, first, obtains the updated-portion content catalog information in the payload portion of the catalog distribution message (step S21), compares version information (version serial number) added to the updated-portion content catalog information with version information (version serial number) added to content catalog information already stored in the storage 12 of itself, and determines whether or not the version information added to the obtained updated-portion content catalog information is older than the latest version information added to the content catalog information already stored in the storage 12 of itself (step S22).

As a result of the comparison, in the case where the version information added to the obtained updated-portion content catalog information is older than the latest version information added to the content catalog information already stored in the storage 12 of itself (for example, in the case where the version serial number “6” added to the updated-portion content catalog information is smaller than the latest version serial number “8” added to the content catalog information already stored) (YES in step S22), the controller 11 adds version information indicative of the new version to the updated-portion content catalog information corresponding to a version newer than the version of the obtained updated-portion content catalog information (for example, the updated-portion content catalog information corresponding to the version serial numbers “7” and “8”), and transmits the resultant information to a node upper than the node which has transmitted the catalog distribution message (for example, the node X which has transmitted the catalog distribution message in the case of the node A, and the node A which has transmitted to the catalog distribution message in the case of the node A1) (step S23). That is, the upper node which transmits the catalog distribution message has the information of the version older than that of the content catalog information of the receiving node. Therefore, the insufficient updated-portion content catalog information is provided for the upper node.

As described above, a case occurs such that the version of content catalog information of an upper node (which is not the node X) which has transferred the catalog distribution message is older than that of content catalog information of the node for the following reason. For example, content catalog information is updated a plurality of times in short intervals, and the updated-portion content catalog information is transmitted from the node X by DHT multicast a plurality of times. When a node participates in or withdraws from the overlay network 9 during the transfer of the updated-portion content catalog information, the transfer path changes. There is a case such that the updated-portion content catalog information of the latest version transmitted from the node X after the updated-portion content catalog information transmitted from the node X first reaches the node itself.

On the other hand, in the case where the version information added to the obtained updated-portion content catalog information is not older (that is, the same or newer) than the latest version information added to the content catalog information already stored in the storage 12 of the node itself (NO in step S22), the controller 11 compares version information added to the obtained updated-portion content catalog information with the latest version information added to content catalog information already stored in the storage 12, and determines whether or not the version information added to the obtained updated-portion content catalog information is equal to (the same as) the latest version information added to the content catalog information already stored in the storage 12 of itself (step S24).

As a result of the comparison, in the case where the version information added to the obtained updated-portion content catalog information is equal to the latest version information added to the content catalog information already stored in the storage 12 of itself (YES in step S24), the process is finished.

As described above, a case occurs such that the content catalog information of an upper node (which is not the node X) which has transferred the catalog distribution message is the same as the content catalog information of the node for the following reason. For example, the updated-portion content catalog information is transmitted from the node X by DHT multicast. When a node participates in or withdraws from the overlay network 9 during the transfer of the updated-portion content catalog information, the transfer path changes. There is a case such that the same updated-portion content catalog information from another path also reaches the node itself afterward.

On the other hand, as a result of the comparison, in the case where the version information added to the obtained updated-portion content catalog information is not equal to (that is, is newer) than the latest version information added to the content catalog information already stored in the storage 12 of the node itself (NO in step S24), the controller 11 compares version information added to the obtained updated-portion content catalog information with the latest version information added to content catalog information already stored in the storage 12, and determines whether or not the version information added to the obtained updated-portion content catalog information is equal to the latest version information added to the content catalog information already stored in the storage 12 of itself by one version (step S25).

As a result of the comparison, in the case where the version information added to the obtained updated-portion content catalog information is newer than the latest version information added to the content catalog information already stored in the storage 12 of itself by one version (for example, in the case where the version serial number added to the updated-portion content catalog information is larger than the latest version serial number added to the content catalog information already stored by one) (YES in step S25), the controller 11 updates the content catalog information and the version information already stored on the basis of the attribute information of content data and the version information written in the updated-portion content catalog information (step S27) and finishes the process. For example, the attribute information of the content data written in the obtained updated-portion content catalog information is additionally registered in the content catalog information already stored, thereby upgrading the version.

As a result of the comparison, in the case where the version information added to the obtained updated-portion content catalog information is not newer than the version information added to the content catalog information already stored by one version (that is, is newer by two or more versions) (for example, the version serial number added to the updated-portion content catalog information is larger than the latest version serial number added to the content catalog information already stored by two or more) (NO in step S25), the controller 11 requests the upper node which has transmitted the catalog distribution message to send updated-portion content catalog information corresponding to version information to be positioned between the two version information (for example, “6” and “7” positioned between the version serial numbers “5” and “8”) (that is, missing updated-portion content catalog information) and obtains the requested information (step S26).

The controller 11 updates the already stored content catalog information and version information on the basis of the updated-portion content catalog information obtained in steps S21 and S26 and their version information (step S27), and finishes the process. For example, the attribute information of the content data written in each of the updated-portion content catalog information obtained in steps S21 and S26 is added to the already stored content catalog information, thereby upgrading the version.

As described above, in the first embodiment, updated-portion content catalog information is distributed to all of nodes participating in the overlay network 9 by the DHT multicast. Consequently, each of the nodes does not have to be connected to the catalog management server to request for the latest content catalog information, so that heavy load can be prevented from being applied to a specific managing apparatus such as the catalog management server. Since each of the nodes always stores the latest content catalog information, the user of each of the nodes can always retrieve the desired latest content from the content catalog information.

For example, only when the content catalog information is updated in the catalog management node, only the updated portion is distributed as the updated-portion content catalog information by the DHT multicast. Therefore, the amount of data transmitted/received can be decreased, and the load on the network 8 and the process load in each of the nodes can be lessened.

Each of the nodes compares the version information added to the received updated-portion content catalog information with the version information added to the content catalog information already stored in the catalog cache area of the node itself. In the case where the version information added to the received updated-portion content catalog information is newer than the version information added to the content catalog information already stored by one, the node updates the updated-portion content catalog information by assembling it into the content catalog information already stored. In the case where the version information added to the received updated-portion content catalog information is newer than the version information added to the content catalog information already stored by two or more versions, the node obtains the updated-portion content catalog information corresponding to the version information to be positioned between both of version information from an upper node, and updates also the obtained updated-portion content catalog information by assembling it in the content catalog information already stored. Therefore, even a node which has been withdrawn for a while can participate in the network again and obtain update-portion content catalog information from a node participating in the network. Thus, the updated-portion content catalog information distributed during withdrawal can be obtained more efficiently not via a specific managing apparatus such as the catalog management server.

Further, each of the nodes compares the version information added to the received updated-portion content catalog information with the version information added to the content catalog information already stored in the catalog cache area of the node itself. In the case where the version information added to the received updated-portion content catalog information is older than the version information added to the content catalog information already stored, the node transmits the updated-portion content catalog information corresponding to the version newer than the version of the received updated-portion content catalog information to an upper node which has transmitted the old content catalog information. Therefore, even in the case where a node participates in or withdraws from the overlay network 9 and the transfer path changes during a period in which updated-portion content catalog information is transmitted a plurality of times in a row from the node X by the DHT multicast and the updated-portion content catalog information is being transferred, the latest content catalog information can be properly distributed to all of the nodes.

### Modification of DHT Multicasting Process

In the DHT multicasting process shown in FIG. 13, each of the nodes transmits a catalog distribution message only to a node whose IP address is stored in a routing table of the node itself. A modification of transmitting a catalog distribution message also to a node whose IP address is not registered (stored) in the routing table will be described with reference to FIGS. 16 to 18.

When a node participates in or withdraws from the overlay network 9, it may not be reflected in the routing table in a certain node. In this case, there is the possibility that the catalog distribution message is not transmitted to all of nodes even by the DHT multicast. In the modification, even such a situation occurs, the catalog distribution message can be transmitted to all of the nodes participating in the overlay network 9.

In the modification, description of parts similar to those in the first embodiment will not be repeated.

The process shown in FIG. 15 is applied also to the modification and executed in a manner similar to the first embodiment.

On the other hand, the process shown in FIG. 13 is not applied to the modification. Instead, the processes shown in FIGS. 16 and 17 are executed. The process shown in FIG. 14 is not also applied to the modification. Instead, the process shown in FIG. 18 is executed.

The header portion in the catalog distribution message transmitted in the modification includes an integration value of the number of transfer times (a value which is incremented each time a message is transferred to a node) and an upper limit value of the number of transfer times. In the case where the catalog distribution message is transmitted to a node whose IP address is not registered in a routing table, there is the possibility that the message is continuously transferred. To prevent this, the above-described values are included.

In the DHT multicasting process shown in FIG. 16, in a manner similar to step S1 in FIG. 13, the controller 11 of the node X generates a catalog distribution message in which the obtained unique ID and the updated-portion content catalog information is included in the payload (step S51).

Subsequently, the controller 11 of the node X sets the node ID “3102” of itself as the target node ID in the header portion of the generated catalog distribution message, sets “0” as the ID mask, and sets the IP address of itself as an IP address (step S52).

Subsequently, the controller 11 starts the catalog distribution message transmitting process (step S53).

In the catalog distribution message transmitting process, as shown in FIG. 17, the controller 11 of the node X determines, as the level designated in the routing table of itself, a value “the number of matching digits from the upper digit of the target node ID in the generated catalog distribution message+1” (step S61).

For example, in the case where the node ID of the node itself is “3102” and the target node ID is “3102”, all of the digits match each other. Consequently, the number of matching digits is “4”. By adding 1 to “4”, the level of the routing table is determined as “5”.

Subsequently, the controller 11 determines whether the determined level is larger than the ID mask in the generated catalog distribution message or not (step S62).

In the above example, the determined level “5” is larger than the ID mask “0” in the catalog distribution message. Consequently, the controller 11 discriminates that the determined level is larger than the ID mask (YES in step S62), and moves to step S63.

In step S63, the controller 11 determines a box (that is, the level and the line) in the routing table of itself. Concretely, the controller 11 determines, as the level designated” “the value of the ID mask in the catalog distribution message+1” and determines, as a column to be designated, one column from the left end of the level.

In the case where the routing table is made of A digits and the number system in base B, the value of the level is 1 to A, and the value of the column is 1 to B. In the case of four digits and the number system in base 4, the level is 1 to 4 (the total number of levels is 4), and the column is 1 to 4 (the total number of columns is 4). In the above example, the ID mask in the catalog distribution message is “0”, so that the box of “level 1 and column 1” in the routing table is designated.

Subsequently, the controller 11 determines whether the value of the determined level is equal to or less than the total number of levels or not (step S64). In the above-described example, the value “1” of the determined level is less than the total number “4” of levels. Therefore, the controller 11 determines that the value of the determined level is equal to or less than the total number of levels (YES in step S64) and, then, determines whether the value of the determined column is equal to or less than the total number of columns (step S65). In the above-described example, the value “1” of the determined column is equal to or less than the total number of columns “4”. Consequently, the controller 11 discriminates that the value of the determined level is equal to or less than the total number of levels (YES in step S65) and then determines whether the determined box indicates itself (the node ID of itself) or not (step S66). In the above-described example, the node ID of the node itself is not registered in the determined box of “level 1, column 1”. Therefore, the controller 11 discriminates that the determined box does not indicate itself (NO in step S66), and moves to step S67.

In step S67, the controller 11 checks to see whether the IP address or the like of the node is registered in the determined box or not. Since the IP address of the node A is registered in the determined box of “level 1, column 1” in the above-described example, the controller 11 decides that the IP address on the like of the node is registered in the determined box (YES in step S67), and transits the catalog distribution message to the registered node (according to the IP address) (step S68).

Subsequently, the controller 11 adds “1” to the value of the determined column (step S69) and returns to step S65.

The processes in steps S65 to S69 are repeatedly performed. For example, the catalog distribution message is transmitted also to the node B registered in the box of “level 1, column 2” and the node C registered in the box of “level 1, column 3” in FIG. 5, the determined box is changed to “level 1, column 4”, and the controller 11 returns to step S65.

After the process of step S65, in the process of step S66, the determined box of “level 1, column 4” indicates the node itself, so that the controller 11 decides that the determined box indicates the node itself (YES in step S66) and moves to step S69. In such a manner, the catalog distribution message can be transmitted to all of the nodes 1 registered in the level 1 in the routing table.

On the other hand, when it is discriminated that the value of the column determined in the process of the step S65 is not equal to or less than the total number of columns (NO in step S65), the controller 11 adds “1” to the value of the ID mask set in the header portion of the catalog distribution message, thereby resetting the ID mask (step S70). The controller 11 returns to step S63, and similar processes are repeated.

On the other hand, in the case where the IP address or the like of the node is not registered in the determined box in the process in the step S67 (NO in step S67), the controller 11 transmits the catalog distribution message to anode stored closest to the determined box (for example, “level 3, column 2”) (step S71). In the above-described example, the value of the ID mask is set to “3”, and the target node ID is set to “3110” corresponding to the box of “level 3, column 2”.

By specifying a target as described above, in the case where a node corresponding to the box participates, the catalog distribution message can be transmitted. In the above-described example, it is sufficient to transmit the catalog distribution message to the node G and transfer it.

The upper limit value of the number of transfer times in the header portion of the catalog distribution message is the value that determines the upper limit of the number of transfer times. The value is provided to prevent the message from continuously being transferred in the case where there is no target node. The upper limit value of the number of transfer times is set to a value which is rather large to an extent that the number of transfer times does not exceed it in normal transfer. For example, in the case of using a routing table having the number of levels which is four, the number of transfer times is normally four or less. In this case, the upper limit value of the number of transfer times is set to, for example, eight, sixteen, or the like.

On the other hand, when it is determined in the process of the step S64 that the value of the determined level is not equal to or less than the total number of levels (NO in step S64), the process is finished.

On the other hand, in the process of the step S61, for example, when the node ID of the node itself is “3102”, the target node ID is “2132”, and the ID mask is “4”, the number of matching digits is “0”. 1 is added to the number “0”, so that the level of a routing table designated is determined as “1”. In this case, the determined level is smaller than the ID mask “4” in the catalog distribution message in the step S62, the controller 11 moves to step S72 where normal DHT message transmitting (transferring) process is performed. Concretely, the controller 11 determines a node closest to the target node ID in the determined level and registered in the routing table, transmits (transfers) the catalog distribution message to the node, and finishes the process.

Each of nodes which receive the catalog distribution message transmitted as described above stores the catalog distribution message and starts the process shown in FIG. 18.

When the process shown in FIG. 18 starts, the controller 11 of the node determines whether the number of transfer times of the catalog distribution message exceeds the upper limit value of the number of transfer times or not (step S81). In the case where it does not exceed the upper limit value of the number of transfer times (NO in step S81), the controller 11 determines whether the node ID of the node itself is included in the target of the received catalog distribution message or not (step S82). In this case where the ID mask in the catalog distribution message is “0”, as described above, the target includes all of the node IDs. Consequently, the controller 11 determines that the node ID of the node itself is included in the target (YES in step S82), changes the target node ID in the header portion of the received catalog distribution message to the node ID of the node itself, changes the ID mask to “the value of the ID mask in the catalog distribution message+1” (step S83), and executes the catalog distribution message transmitting process shown in FIG. 17 on the catalog distribution message (step S84). After finishing the catalog distribution message transmitting process, in a manner similar to the first embodiment, the controller 11 executes the catalog information receiving process shown in FIG. 15 (step S85) and finishes the process.

On the other hand, in the case where it is determined that the node ID of the node itself is not included in the target in the process of the step S82 (NO in step S82), the controller 11 executes the catalog distribution message transmitting process shown in FIG. 17 on the received catalog distribution message (step S86), and finishes the process.

On the other hand, in the case where it is determined that the number of transfer times of the received catalog distribution message exceeds the upper limit value of the number of transfer times in the process of the step S81 (YES in step S81), the process is finished without transferring the message.

As described above, in the modification of the DHT multicasting process, when a node participates in or withdraws from the overlay network 9, even in the case where the participation or withdrawal is not reflected yet in the routing table of a certain node, the catalog distribution message can be transmitted to all of the nodes participating in the overlay network 9.

### 3.2 Second Embodiment

### 3.2.1 Operation of Storing Content Catalog Information

The operation of the content distribution system S in a second embodiment will now be described. In the second embodiment, description of parts similar to those of the foregoing first embodiment will not be repeated.

FIGS. 13, 14, 16, 17, and 18 are also applied to the second embodiment and the processes are executed in a manner similar to the first embodiment or the modification.

On the other hand, the process shown in FIG. 15 is not applied to the second embodiment. Instead, the process shown in FIG. 19 is executed.

In the first embodiment, each of the nodes participating in the overlay network 9 stores all of content catalog information. A situation is, however, expected that when the number of pieces of content entered on the content distribution system S becomes enormous, the amount of content catalog information becomes too large, and the information cannot be stored in the catalog cache area in a single node.

In the second embodiment, a service range of content data is determined (the wider the range is, the more content catalog information in which attribute information of content data is written can be stored, and the narrower the range is, the less the content catalog information in which attribute information of content data is written is stored). Content catalog information in which attribute information of content data is written is stored. The content data is in the service range of the node itself in content data corresponding to an area to which the node belongs (an area in the node ID space) (for example, to an area whose highest digit is “0” (area of “0xxx”) content data having content IDs whose highest digit is “0” corresponds). The content catalog information is spread to a plurality of nodes.

The “service range” is expressed by, for example, “range” indicative of the number of matching digits from the highest digit between a node ID and a content ID (an example of service range information indicative of service range). For example, in the case where the “range”=1, it means that at least the highest digit of the node ID and that of the content ID have to match. In the case where the “range”=2, it means that at least the highest digits and the next highest digits have to match. The wider the service range is, the smaller the digit of the “range” is.

Each node stores the “range” stores content catalog information in which the attribute information of content data is written, using content data having a content ID matching a predetermined digit in the digits indicated by the “range” in the node ID of the node itself as content data in the service range of the node itself. For example, a node whose node ID is “0132” and whose range is 1 stores content catalog information in which attribute information of all of content data having content IDs whose highest digit is “0” (the highest digit matches) is written using the content data as content data in the service range of the node itself. A node whose node ID is “1001” and whose range is 2 stores content catalog information in which attribute information of all of content data having content IDs whose upper two digits are “10” is written using the content data as content data in the service range. In the case where the “range” 0, all of the content catalog information is stored. It does not prevent each of nodes from storing content catalog information in which attribute information of content data out of the service range of the node itself. It assures that a node stores at least the attribute information of content data in the service range for the other nodes.

The “range” is arbitrarily set in each of nodes. For example, the range is set so that the smaller the storage capacity of a catalog cache area is, the narrower the range is (in other words, the larger the storage capacity of the catalog cache area is, the wider the range is). When the storage capacity is large, the “range” may be set as zero.

With reference to FIG. 19, the catalog information receiving process in a certain node will be concretely described. It is assumed that, in each of nodes participating in the overlay network 9, at least content catalog information in which attribute information of content data in the service range of the node itself is written is stored.

In the catalog information receiving process in the second embodiment, as shown in FIG. 19, the controller 11 of the node which received the catalog distribution message obtains an updated-portion content catalog information in the payload portion of the catalog distribution message in a manner similar to the first embodiment (step S101). The processes in steps S102 to S105 shown in FIG. 19 are similar to those in the steps S21 to S25 shown in FIG. 15.

As a result of the comparison in the step S105, in the case where the version information added to the obtained updated-portion content catalog information is newer than the latest version information added to the content catalog information already stored in the storage 12 of itself by one version (YES in step S105), the controller 11 specifies content data in the service range indicated by the “range” of the node itself in content data whose attribute information is written in the updated-portion content catalog information (for example, content data having a content ID whose predetermined number of digits (the predetermined number of upper digits) matching the node ID of the node itself, which is indicated by the “range” of the node itself). The controller 11 updates the content catalog information related to the specified content data (step S107). For example, the attribute information of the specified content data is additionally registered in the content catalog information already stored, thereby upgrading the version.

As a result of the comparison in the step S105, in the case where the version information added to the obtained updated-portion content catalog information is not newer than the version information added to the content catalog information already stored by one version (that is, is newer by two or more versions) (NO in step S105), the controller 11 requests the upper node which has transmitted the catalog distribution message to send updated-portion content catalog information corresponding to version information to be positioned between the two version information (that is, missing updated-portion content catalog information) (transmits a request message including the version information of the missing updated-portion content catalog information) and obtains it. The controller 11 specifies the content data in the service range indicated by the “range” of the node itself (step S106).

In the case where an upper node that received the request for the missing updated-portion content catalog information does not store the updated-portion catalog information which is out of the service range of itself, the upper node requests a further upper node for the missing updated-portion content catalog information. Until the missing updated-portion content catalog information is obtained, the request is sent to a higher node (if the request reaches to the node X as the transmitter of the catalog distribution message, the missing updated-portion content catalog information is obtained).

Subsequently, the controller 11 specifies content data in the service range indicated by the “range” of the node itself in content data whose attribute information is written in the updated-portion content catalog information obtained in the step S101 (for example, content data having a content ID whose predetermined number of digits (the predetermined number of upper digits) matching the node ID of the node itself, which is indicated by the “range” of the node itself). The controller 11 updates the specified content data and the content catalog information related to the content data specified in the step S106 (for example, newly registers the attribute information of the specified content data) (step S107).

After that, the controller 11 updates the version information added to the already stored content catalog information on the basis of the version information added to the updated-portion content catalog information obtained in the step S101 (step S108), and finishes the process.

Even if no content data is specified from content data whose attribute information is written in the updated-portion content catalog information obtained in the step S101 (that is, in the case where the content data whose attribute information is written in the updated-portion content catalog information is out of the service range of the node itself), the version information added to the already stored content catalog information is updated to the version information added to the updated-portion content catalog information obtained in the step S101 (to the latest version information), and the resultant information is stored. The operation is performed for the reason that, when the updated-portion content catalog information is received again afterward, the information has to be compared with the version of the received information.

The controller 11 determines whether or not the data amount of the content catalog information stored in a catalog cache area in the storage 12 of itself becomes equal to or larger than a predetermined amount (for example, a data amount of 90% of the maximum capacity of the catalog cache area or more) (step S109). In the case where the data amount becomes equal to or larger than the predetermined amount (YES in step S109), “1” is added to the “range” of the node itself (that is, the service range of the node itself is changed to be narrowed) (step S110). The controller 11 deletes, from the content catalog information, attribute information of content data which becomes out of the range when the “range” is increased (the service range is narrowed) in the content data whose attribute information is written in the content catalog information stored in the catalog cache area (step S111), and finishes the process. In such a manner, the storage capacity of the catalog cache area can be assured. On the other hand, in the case where the amount of the content catalog information has reached the predetermined amount or more (NO in step S109), the process is finished.

As described above, in the operation of storing the content catalog information in the second embodiment, a service range of content data is determined for each of the nodes participating in the overlay network 9. In content data corresponding to an area to which a node belongs (an area in the node ID space), content catalog information in which attribute information of content data in the service range of the node itself is written is stored. With the configuration, the content catalog information is spread to a plurality of nodes. Therefore, a problem does not occur such that when the number of pieces of content entered on the content distribution system S becomes enormous, the amount of content catalog information becomes too large, and the information cannot be stored in the catalog cache area in a single node. By searchably, dispersedly arranging all of the content catalog information on the content distribution system S, each of the nodes can use all of the content catalog information.

Moreover, as content data in the service range of each node, content data corresponding to a content ID whose predetermined digit (for example, the highest digit) matches that of the node ID of the node itself is set. Consequently, the service range can be determined for each of boxes in the routing table of the DHT (table entries). Each node can easily know that a node registered in a box in the routing table of the DHT of the node itself may hold content catalog information of content data in a range.

For example, in the case where each of a node ID and a content ID is made of 16 digits in a number system in base 16, the content catalog information can be divided into 16 parts 0 to F as target digits in the level 1 of the routing table.

The service range of each node is specified by a “range” indicative of the number of matching digits from the highest digit between a node ID and a content ID. The wider the service range is, the smaller the number of digits is. Since the range of each node can be determined arbitrarily, the size (data amount) of content catalog information to be stored can be determined node by node. Further, it can be set so that the smaller the storage capacity of the catalog cache area is, the narrower the range is (in other words, the larger the storage capacity is, the wider the range is). The amount of content catalog information which can be stored can be set according to the storage capacity in each node. Even if the storage capacities of nodes are various, the content catalog information can be properly spread.

In a manner similar to the first embodiment (or the modification of the DHT multicasting process), the updated-portion content catalog information is distributed to all of the nodes participating in the overlay network 9 by the DHT multicast. Each of the nodes which receive the information updates the information by adding only the updated-portion content catalog information related to the content data in the service range of the node itself to the content catalog information already stored. Therefore, each of the nodes can always store the latest content catalog information in the service range of itself.

Further, in the case where the amount of the content catalog information stored in the catalog cache area of the node itself becomes equal to or larger than a predetermined amount, each of nodes which receives the updated-portion content catalog information and stores the information corresponding to the service range of the node itself changes the service range so as to be narrowed. Attribute information of content data which becomes out of the service range when the service range is narrowed in the content data whose attribute information is written in the content catalog information stored in the catalog cache area is deleted from the content catalog information. Thus, the storage capacity of the catalog cache area can be assured.

### 3.2.2 Operation of Retrieving Content Catalog Information

A method of retrieving the content catalog information stored so as to be spread to nodes as described will now be described.

FIG. 20A is a diagram showing an example of the routing table of the node I. FIG. 20B is a conceptual diagram showing a state where a catalog search request is transmitted from the node I.

In the example of FIG. 20B, the “range” of the node I is “2”. The service range of the node I whose node ID is “3102” is “31”. The node I stores content catalog information in which attribute information of content data each having a content ID whose upper two digits are “31” is written (registered). Therefore, the attribute information of content data each having a content ID whose upper two digits are “31” can be retrieved from the content catalog information of the node itself.

However, in the node I, the attribute information of content data having content IDs whose upper two digits are not “31” is not written (registered) in the content catalog information of the node itself. Consequently, an inquiry is sent to a representative node in each of the areas registered in the routing table of the node itself for the attribute information (a catalog search request using a search keyword for searching content catalog information). That is, the node I sends the catalog search request to representative nodes belonging to the areas corresponding to values other than the values “31” of the predetermined number of digits to be matched, which is indicated by the “range” of the node itself (for example, upper two digits).

In the example of FIG. 20B, the node I sends catalog search requests on content catalog information in which the attribute information of content data having content IDs whose highest digits are “0”, “1”, and “2” is written to the nodes A, B, and C registered in the first stage (level 1) in the routing table of the node I itself.

Further, in the example of FIG. 20B, the node I sends catalog search requests on content catalog information in which the attribute information of content data having content IDs whose upper two digits are “30”, “32”, and “33” is written to the nodes D, E, and F registered in the second stage (level 2) in the routing table of the node I itself. That is, in the case where the service range of the node I itself is a part (in this case, “31”) of the range of the content data corresponding to the area to which the node I itself belongs (in this case, content data having a content ID whose highest digit is “3”), a catalog search request is transmitted to representative nodes belonging to small plural areas obtained by dividing the area to which the node I itself belongs.

Further, in the example of FIG. 20B, the “range” of the node B is “2”, so that the service range of the node B whose node ID is “1001” is “10”. Therefore, the node B sends catalog search requests on content catalog information to nodes B1, B2, and B3 with respect to attribute information of content data having content IDs whose upper two digits are not “10” (that is, “11”, “12” and “13”). That is, in the case where the service range of the node B itself is a part of the range of the content data corresponding to the area to which the node B itself belongs, the node B sends a catalog search request to representative nodes belonging to small plural areas obtained by dividing the area to which the node B itself belongs.

In the case where the “range” of the node I is “1”, the attribute information of content data having content IDs whose upper digits are “30”, “32”, and “33” is also written (registered) in the content catalog information, the node I does not have to send the catalog search request to the nodes D, E, and F registered in the second stage (level 2) in the routing table of the node itself.

Each of nodes which received the catalog search request retrieves the content catalog information in which the attribute information of the content data satisfying an instructed search condition (including a search keyword) is written from the catalog cash area of the node itself and sends back a search result including the content catalog information to the node as the catalog search requester. The reply may be sent to the node as the catalog search requester directly, or via an upper node (for example, in the case of the node B1, to the node I via the node B).

Referring to FIGS. 21 to 23, processes in nodes in which the catalog search request are made will be described concretely.

FIG. 21 is a flowchart showing the catalog retrieving process in a node. FIG. 22 is a flowchart showing the details of catalog retrieval request process in FIG. 21. FIG. 23 is a flowchart showing process in a node which receives a catalog retrieval request message.

For example, in the node I, in the case where a catalog display instruction is entered from the user via the input unit 21, a not-shown catalog displaying process starts. A catalog as shown in FIGS. 5A to 5C is displayed on the display unit 16.

When the user enters a desired search keyboard (for example, jazz) is entered by operating the input unit 21 in such a display state, the catalog retrieving process shown in FIG. 21 starts (the catalog display process shifts to the catalog retrieving process). The controller 11 of the node I obtains the entered search keyword as a search condition (step S201) and obtains the “range” from the storage 12.

Subsequently, the controller 11 determines whether the obtained “range” is larger than “0” or not (step S202). In the case where the range is not larger than “0” (NO in step S202), all of the content catalog information is stored. The controller 11 retrieves and obtains the content catalog information in which the attribute information corresponding to the obtained search keyword is written from the content catalog information stored in the catalog cash area of the node itself (step S203). The controller 11 selectably displays a list of attribute information (for example, a genre list) written in the content catalog information, for example, on the catalog displayed on the display unit 16 (presents the search result to the user) (step S204), finishes the process, and returns to the catalog displaying process. In the catalog display process, when a search keyword is entered again from the user (for example, limiting by an artist name), the catalog retrieving process starts again. When a content name is selected on the catalog displayed on the display unit 16, as described above, the content ID of the content data is obtained, and a content location inquiry message including the content ID is transmitted to the root node.

On the other hand, when the obtained range is larger than “0” (that is, in the case where all of the content catalog information is not stored) (YES in step S202), the controller 11 generates a catalog search request message as search request information including the IP address or the like of the node itself and having a header portion in which the level lower limit value “lower” is set as 1, the level upper limit value “upper” is set as 2, and the upper limit value “nforward” of the number of transfer times is set as 2, and a payload portion including a unique ID (for example, an ID peculiar to the catalog search request message) and the obtained search keyword as a search condition (step S205). By the level lower limit value “lower” and the level upper value “upper”, a message transmission range in the routing table can be specified. For example, when the level lower limit value “lower” is set as 1 and the level upper limit value “upper” is set as 2, all of nodes registered in the levels 1 and 2 in the routing table are destinations of the message.

Subsequently, the controller 11 performs a catalog search request process (step S206).

In the catalog search request process, as shown in FIG. 22, first, the controller 11 determines whether the level upper limit value “upper” set in the header portion of the catalog search request message is equal to or larger than the level lower limit value “lower” (step S221). In the case where it is equal to or larger than the level lower limit value “lower” (YES in step S221), a box to be designated (that is, level and column) in the routing table of the node itself is determined (step S222). Concretely, the controller 11 determines the level lower limit value “lower” in the catalog search request message as a level to be designated, and determines the first column from the lower end of the level as a column to be designated.

Subsequently, the controller 11 determines whether an IP address is registered in a determined box or not (step S223). In the case where it is registered (YES in step S223), the controller 11 sets the node ID in the determined box as the target node ID in the header portion of the catalog search request message, sets the IP address in the determined box (step S224), and transmits the catalog search request message to a representative node registered in the determined box (step S225).

On the other hand, in the case where the IP address is not registered in the determined box (NO in step S223) the controller 11 adds “1” to the upper limit value “nforward” of the number of transfers (to increase the upper limit value of the number of transfer times so that the message reaches the node belonging to the area) (step S226), sets an arbitrary node ID which can be registered in the determined box as a target node ID in the header portion of the catalog search request message (for example, in the case of an area where the target digit is “0”, any value starting from “0” (the highest digit), sets the IP address of a node registered (stored) in a closest box in the same level as the determined box (for example, the neighboring box on the right side) (step S227), and transmits the catalog search request message to the node registered in the closest box (step S225). As a result, the message is finally transferred to the node of an arbitrary node ID which can be registered in the determined box (the representative node belonging to the area) or discarded when the number of transfer times reaches the upper limit value of the number of transfer times.

Subsequently, the controller 11 adds “1” to the value of the determined column (step S228) and determines whether the resultant value of the column is equal to or less than the total number of columns or not (step 229). In the case where it is equal to or less than the total number of columns (YES in step S229), the controller 11 returns to the step S223, performs process similar to the above, and repeats the process until the process on the boxes at the right-end column in the same level is finished.

In the case where the resultant value becomes not equal to or less than the total number of columns (NO in step S229), the controller 11 adds “1” to the level lower limit value “lower” (step S230), returns to the step S221 where the level upper-limit value “upper” is equal to or larger than the resultant level lower limit value “lower” or not is determined, and repeats the process until the level upper limit value “upper” becomes not equal to or larger than the resultant level lower-limit value “lower”. That is, the process is performed on each of the boxes in the level in the routing table indicated by the level upper limit value “upper” (in this case, the level 2). When the level upper-limit value “upper” becomes not equal to or larger than the level lower-limit value “lower” (NO in step S221), the controller 11 returns to the process shown in FIG. 21.

As described above, according to the IP addresses of representative nodes belonging to areas in the routing table, the catalog search request message is transmitted to the representative nodes belonging to the areas.

Each of the nodes which received the catalog search request message transmitted as described above temporarily stores the catalog search request message and starts the process shown in FIG. 23.

When the process shown in FIG. 23 starts, the controller 11 of the node subtracts “1” from the upper limit value “nforward” of the number of transfer times in the header portion of the catalog search request message (step S241) and determines whether the node ID of the node itself is included in the target of the received catalog search request message (step S242). For example, when the node ID of the node itself and the target node ID in the header portion of the catalog search request message match each other, it is determined that the node ID of the node itself is included in the target (YES in step S242), and the controller 11 determines whether the upper limit value “nforward” of the number of transfer times subtracted is larger than “0” or not (step S243).

In the case where the upper limit value “nforward” of the number of transfer times is larger than “0” (YES in step S243), the controller 11 adds “1” to the level lower-limit value “lower” (step S244), performs the catalog search request process shown in FIG. 22 (step S245), and shifts to step S246. The catalog search request process is as described above. The node transfers the catalog search request message to lower nodes (representative nodes registered in the boxes in the level 2 in the routing table).

On the other hand, in the case where the upper limit value “nforward” of the number of times is not larger than “0” (or becomes “0”) (NO in step S243), the controller 11 moves to the step S246 without transferring the catalog search request message.

In step S246, the controller 11 obtains a search keyword as a search condition in the payload portion of the catalog search request message and retrieves content catalog information in which the attribute information of content data satisfying the search condition (for example, matching the search keyword “jazz”) is written from the catalog cache area of the node itself.

The controller 11 generates a search result message including the retrieved content catalog information, search result information including a service range of itself (for example, “10”) as a search range, and a unique ID in the catalog search request message, sends (returns) the message to the node I as the transmitter of the catalog search request message (step S247), and finishes the process.

On the other hand, in the case where it is determined in the process of the step S242 that the node ID of the node itself is not included in the target of the received catalog search request message (NO in step S242), the controller 11 determines whether the upper limit value “nforward” of the number of transfer times subtracted is larger than “0” or not (step S248). In the case where the upper limit value is larger than “0” (YES in step S248), like normal DHT routing, the controller 11 obtains the IP address or the like of a node having the node ID closest to the target ID (for example, having the largest number of matched upper digits) in the header portion of the catalog search request message, and transfers the catalog search request message to the IP address or the like (step S249). In the case where the upper limit value is not larger than “0” (NO in step S248), the process is finished.

Returning to the process shown in FIG. 21, the controller 11 of the node I receives the search result message returned from another node (YES in step S207) and temporarily stores the unique ID and the search result information included in the message in the RAM (step S208). Until preset time (preset time since the catalog search request message has been transmitted in the catalog search request process) elapses and times out, reception of the search result message is waited, the search result message is received, and the unique ID and the search result information included in each of received search result messages is stored.

When times out (YES in step S209), the controller 11 sums up the search result information corresponding to the same unique ID, and determines whether the search range included in the result covers all of an expected range (the range out of the service range of the node itself) (that is, determines whether or not there is a range which is not searched for content catalog on the basis of search ranges included in all of the received search result information) (step S210). In the case where the search range does not cover all of the expected range (there is a range which is not searched) (NO in step S210), the controller 11 inquires the node X as a catalog management node, or a catalog management server for only the uncovered range (unsearched range), and obtains and adds content catalog information in which attribute information of content data satisfying the search condition of the range is written (step S211).

Subsequently, the controller 11 of the node I retrieves and obtains, from the catalog cache area of the node itself, the content catalog information in which the attribute information of content data satisfying the search condition (for example, matching the search keyword “jazz”) is written from the content catalog information in which the attribute information of the content data of the service range of itself is written (step S203). The controller 11 selectably displays a list of the attribute information written in the content catalog information covering all of the range, for example, on the catalog displayed on the display unit 16 (presents the search result to the user) (step S204), finishes the process, and returns to the catalog displaying process.

As described above, by the operation of retrieving the content catalog information in the second embodiment, each node can efficiently send a catalog search request (catalog search request message) on content catalog information of the content data output the service range of the node itself to representative nodes registered in boxes, for example, in levels 1 and 2 in the routing table of the DHT of the node itself by DHT multicast. Therefore, each of the nodes can retrieve desired content catalog information more efficiently using a smaller message amount.

A node which has sent the catalog search request can obtain search results of ranges from the representative nodes, so that it does not have to store all of the content catalog information.

When the size of the content catalog information becomes great, the load of the searching process in each of nodes which have received the catalog search request also increases. By the method of the second embodiment, the content catalog information is dispersed almost evenly (since the content IDs themselves are spread without big intervals in the node ID space). Therefore, the load of the search process in the nodes is also evenly dispersed, the search speed can be improved, and the network load can be also spread.

Further, since the content catalog information is dispersed by the nodes autonomously, there is also a merit that, for example, information collection and management by the server is unnecessary. That is, the administrator just distributes, for example, updated-portion content catalog information from the catalog management node by the DHT multicast. Each of the nodes determines whether the information is in its service range or not on the basis of the node ID, the content ID, and the “range” and stores only the content catalog information related to the content data in its service range. Thus, the content catalog information can be dispersed autonomously.

### Modification of Catalog Retrieving Process

In the catalog retrieving process shown in FIGS. 21 and 22, a node that receives a catalog search request message recognizes the upper limit value “nforward” of the number of transfer times irrespective of the service range of itself and transfers the catalog search request message to a lower node. A modification of the catalog retrieving process will be described with reference to FIGS. 24 to 26. Only in the case where the service range of a node that receives the catalog search request message is a part of the range of the content data corresponding to the area to which the node belongs, the node transfers the catalog search request message to representative nodes belonging to small plural areas obtained by dividing the area to which the node belongs.

In the modification, description of parts similar to those in the second embodiment will not be repeated.

The process shown in FIG. 22 is applied also to the modification and executed in a manner similar to the second embodiment.

On the other hand, the process shown in FIG. 21 is not applied to the modification. Instead, the processes shown in FIGS. 24 and 25 are executed. The process shown in FIG. 23 is not also applied to the modification. Instead, the process shown in FIG. 26 is executed.

### Process of Node I

In a manner similar to the process shown in FIG. 21, the catalog retrieving process shown in FIG. 24 starts when the user enters a desired search keyword (for example, jazz) by operating the input unit 21 in a state where a catalog as shown in FIG. 5 is displayed on the display unit 16 (shifts from the catalog displaying process). The controller 11 of the node I obtains the entered search keyword as a search condition (step S301) and also obtains “range” from the storage 12.

Subsequently, the controller 11 shifts to a catalog retrieving process α shown in FIG. 25 (step S302).

In the catalog retrieving process α, as shown in FIG. 25, first, the controller 11 of the node I determines whether or not the obtained range of the node itself is larger than a “request search range N” which is set in advance by the user via the input unit 21 (step S311).

The request search range N is provided to determine a content data search range. For example, when the request search range N is set to “0”, the content data in the entire range becomes an object to be retrieved. As the value increases, the search range is narrowed.

In the case where the “range” of the node itself is not larger than the request search range N (for example, in the case where “range”=0 and the request search range N=0) (NO in step S311), the controller 11 retrieves and obtains, from the content catalog information stored in the catalog cache area of the node itself, content catalog information in which the attribute information matching the obtained search keyword is written from the attribute information of content data having content IDs whose upper N (request search range) digits match those of the node ID of the node itself out of the content IDs of content data whose attribute information is written in the content catalog information of the node itself (when the request search range=0, all of digits do not have to match, so that contents ID of all of content data become targets) (step S312). The controller 11 returns to the process shown in FIG. 24, selectably displays a list of the attribute information, for example, on the catalog displayed on the display unit 16 (presents a search result to the user) (step S303), finishes the process and, in a manner similar to the process shown in FIG. 21, returns to the catalog displaying process.

On the other hand, in the case where the “range” of the node itself is larger than the request search range N (for example, in the case where range=2 and the request search range N=0) (YES in step S311), the controller 11 generates a catalog search request message including the IP address of itself and as search request information having a header portion in which, for example, the level lower limit value “lower” is set as “request search range N+1”, the level upper limit value “upper” is set as “range of the node itself”, and the upper limit value “nforward” of the number of transfer times is set as “1”, and a payload portion including, as search conditions, the unique ID and the obtained search keyword (step S313).

As described above, the message transmission range in the routing table can be specified by the level lower-limit value “lower” and the level upper-limit value “upper”. Consequently, for example, in the case where range=2 and the request search range N=0, the level lower-limit value “lower” becomes 1 and the level upper-limit value “upper” becomes equal to 2. All of nodes (in the example of FIG. 20, nodes A, B, C, D, E, and F) registered in the levels 1 and 2 in the routing table are destinations of the message. For example, in the case where range=2 and the request search range N=1, the level lower-limit value “lower” becomes 2 and the level upper-limit value “upper” becomes equal to 2. All of nodes registered only in the level 2 in the routing table are destinations of the message.

Subsequently, the controller 11 performs a catalog search requesting process shown in FIG. 22 (step S314). The catalog search requesting process is similar to that of the second embodiment. According to the IP addresses of representative nodes belonging to areas in a routing table, a catalog search request message is transmitted to the representative nodes belonging to the areas.

Each of nodes which receive the transmitted catalog search request message temporarily stores the catalog search request message and starts the process shown in FIG. 26.

When the process shown in FIG. 26 starts, the controller 11 of the node sets, as the request search range N, a value obtained by adding “1” to the number of matched digits (matched upper digits) between the node ID of the node I as the transmitter of the catalog search request message and the node ID of the node itself (step S331). The controller 11 obtains a search keyword in the catalog search request message as a search condition, further obtains the “range” of the node itself from the storage 12, and moves to the catalog retrieving process a shown in FIG. 25 (step S332).

### Process of Node A

In the case where a node which received a catalog search request message is, for example, the node A shown in FIG. 20, in step S311 in the catalog retrieving process a shown in FIG. 25, the range (=1) of the node itself is not larger than the request search range N (=1), the controller 11 shifts to step S312. The controller 11 of the node A retrieves and obtains, from content catalog information stored in the catalog cache area of the node itself, content catalog information whose attribute information matching the obtained search keyword is written from the attribute information of content data having content IDs whose upper N (=1) digit matching the node ID (0132) of the node itself (that is, content IDs whose highest digit is “0”) in the content IDs of content data whose attribute information is written in the content catalog information of the node itself. After that, the controller 11 returns to the process shown in FIG. 26.

In step S333 shown in FIG. 26, the controller 11 of the node A generates a search result message including the content catalog information retrieved in the step S312, the search result information including the service range of the node itself (for example, “0”) as a search range, and the unique ID in the catalog search request message, transmits (returns) the message to the node I as the transmitter of the catalog search request message, and finishes the process.

### Process of Node B and the Like

On the other hand, in the case where a node which received a catalog search request message is, for example, the node B shown in FIG. 20, in step S311 in the catalog retrieving process α shown in FIG. 25, the range (=2) of the node itself is not larger than the request search range N (=1), the controller 11 shifts to step S313. The controller 11 of the node B generates a catalog search request message including the IP address and the like of itself and, as search request information, having a header portion in which, for example, the level lower-limit value “lower” is set as “request search range N(=1)+1”, the level upper-limit value “upper” is set as “range (=2) of the node itself”, and the upper limit value “nforward” of the number of transfer times is set as “1”, and a payload portion including, as search conditions, the unique ID and the obtained search keyword. In this case, the level lower-limit value “lower” becomes equal to 2, the level upper-limit value “upper” becomes equal to 2, and the nodes B1, B2, and B3 registered in the level 2 in the routing table become destinations of the message.

The controller 11 of the node B performs a catalog search request process shown in FIG. 22, and transmits the catalog search request message to the nodes B1, B2, and B3. The nodes B1, B2, and B3 which receive the catalog search request message perform the process shown in FIG. 26 (through the process of FIG. 25 in a manner similar to the node A), generates a search result message including search result information including content catalog information retrieved and obtained by itself and the service range of the node itself as a search range, and the unique ID in the catalog request message, transmits (returns) the message to the node B as the transmitter of the catalog search request message, and finishes the process.

Returning to the process shown in FIG. 25 performed by the node B, the controller 11 of the node B receives search result messages returned from the nodes B1, B2, and B3 (ideally, from all of the nodes B1, B2, and B3 but there may be a case that the message is not returned due to withdrawal or the like) (YES step S315). The controller 11 temporarily stores the unique ID included in each of the messages and search result information into the RAM (step S316). Until preset time (preset time since the catalog search request message has been transmitted in the catalog search request process) elapses and times out, reception of the search result message is waited, the search result message is received, and the unique ID and the search result information included in each of received search result messages is stored.

When times out (YES in step S317), the controller 11 of the node B sums up the search result information corresponding to the same unique ID, and determines whether the search range included in the result covers all of an expected range (the range out of the service range of the node itself, in this case, “11”, “12”, and “13”) (step S318) In the case where the search range does not cover all of the expected range (NO in step S318), the controller 11 inquires the node X as a catalog management node, or a catalog management server for only the uncovered range, and obtains and adds content catalog information in which attribute information of content data satisfying the search condition of the range is written (step S319).

Subsequently, the controller 11 of the node B sets the value of the “range” (=2) of the node itself as the request search range N (converts N by substitution) (step S320), retrieves and obtains, from content catalog information stored in the catalog cache area of the node itself, the content catalog information in which the attribute information matching the obtained search keyword is written, from the attribute information of the content data having content IDs whose upper N (=2) digits match those of the node ID (1001) of the node itself, out of content IDs of content data whose attribute information is written in the content catalog information of the node itself (that is, content IDs whose upper digits are “10”) (step S312), and returns to the process shown in FIG. 26.

In step S333 shown in FIG. 26, the controller 11 of the node B generates a search result message including the content catalog information obtained in the steps S316, S319, and S312, the search result information including all of the search ranges including the service range of the node itself (in this case, “10”, “11”, “12”, and “13”, that is, “1”), and the unique ID in the catalog search request message, transmits (returns) the message to the node I as the transmitter of the catalog search request message, and finishes the process.

### Process of Node I

Returning to the process shown in FIG. 25 performed by the node I, the controller 11 of the node I receives search result messages returned from the nodes A, B, and the like (YES step S315). The controller 11 temporarily stores the unique ID included in each of the messages and search result information into the RAM (step S316). Until preset time (preset time since the catalog search request message has been transmitted in the catalog search request process) elapses and times out, reception of the search result message is waited, the search result message is received, and the unique ID and the search result information included in each of received search result messages is stored.

When times out (YES in step S317), the controller 11 of the node I sums up the search result information corresponding to the same unique ID, and determines whether the search range included in the result covers all of an expected range (the range out of the service range of the node itself (for example, “0”, “1”, “2”, “30”, “32” and “33”) (step S318) In the case where the search range does not cover all of the expected range (NO in step S318), the controller 11 inquires the node X as a catalog management node, or a catalog management server for only the uncovered range, and obtains and adds content catalog information in which attribute information of content data satisfying the search condition of the range is written (step S319).

Subsequently, the controller 11 of the node I sets the value of the “range” of the node itself as the request search range N (converts N to, for example, “2” by substitution) (step S320), retrieves and obtains, from content catalog information stored in the catalog cache area of the node itself, the content catalog information in which the attribute information matching the obtained search keyword is written, from the attribute information of the content data having content IDs whose upper N digits match those of the node ID (3102) of the node itself (for example, in the case where N=2, content IDs whose upper two digits are “31”), out of content IDs of content data whose attribute information is written in the content catalog information of the node itself (step S312), and returns to the process shown in FIG. 24.

In step S303 shown in FIG. 24, the controller 11 selectably displays a list of attribute information written in the obtained content catalog information on a catalog displayed on the display unit 16 (presents a search result to the user) (step S303), finishes the process, and in a manner similar to the process shown in FIG. 21, returns to the catalog display process.

As described above, according to the modification of the catalog retrieving process, a node which received a catalog search request (catalog search request message) sends a catalog search request to lower nodes (that is, representative nodes belonging to a plurality of small areas obtained by dividing the area to which the node belongs) with respect to content catalog information related to content data out of the service range of the node itself, obtains search results from the nodes, and returns the search results with the search result of the range of the node itself to a node as the catalog search requester. Thus, the search result can be returned more efficiently and reliably.

As compared with the process in which a node which receives a catalog search request transfers the catalog search request to lower nodes like the catalog retrieving process shown in FIGS. 21 and 22, the network load can be reduced.

Obviously, the catalog retrieving process is not limited to the mode in which content catalog information is distributed by DHT multicast and stored but can be also applied to a mode in which content catalog is dispersedly stored in a plurality of nodes in advance (for example, at the time of shipment of each node, content catalog information in the service range of the node itself is stored).

In the foregoing embodiments, each node may preferentially register, in consideration of locality, nodes close to the node itself on a network (for example, the number of hops is small) in boxes in a routing table of a DHT of the node itself.

For example, anode transmits a confirmation message to a plurality of nodes which can be registered in a certain box in a routing table of the node itself, obtains TTL (Time To Live) between each of the nodes and the node itself from reply messages sent back from the nodes, compares the TTLs, and preferentially registers a node closest to the node itself on the network (for example, having the largest TTL (the number of hops is the smallest)) into the routing table of the DHT of the node itself.

With such a configuration, each node sends a catalog search request to a close node on a network, so that locality is reflected also in the retrieving process, and the network load can be further reduced.

Although the embodiments are applied to content catalog information as common information to be commonly used by a plurality of nodes in the content distribution system S, they may be also applied to other common information.

Although the embodiments are described on precondition of using the overlay network 9 configured by an algorithm using a DHT, the present invention is not limited to the precondition.

The present invention is not limited to the foregoing embodiments. The embodiments are illustrative and any variations having the substantially same configuration and producing similar effects as the technical ideals described in the scope of claims of the present invention are considered to be within the technical scope of the present invention.

1. A node device included in an information communication system having a plurality of node devices capable of performing communication with each other via a network, the plurality of node devices being divided in a plurality of groups according to a predetermined rule,
the node device comprising:
destination information storing means for storing destination information of representative node devices belonging to the groups;
content catalog information receiving means for receiving content catalog information transmitted from another node device, the content catalog information in which attribute information of content data which can be obtained by the information communication system is written;
content catalog information transmitting means, in the case where the group to which the node device itself belongs is further divided in a plurality of groups in accordance with the predetermined rule, for transmitting the received content catalog information to the representative node devices belonging to the groups in accordance with destination information of the representative node devices belonging to the groups further divided; and
content catalog information storing means for storing all or part of the received content catalog information.

2. The node device according to claim 1,
wherein each time content catalog information stored in another node device is updated, attribute information of content data of an updated portion in the content catalog information is written in the content catalog information, the resultant information is transmitted as updated-portion content catalog information,
the content catalog information receiving means receives the updated-portion content catalog information transmitted from another node device,
in the case where the group to which the node device itself belongs is further divided in a plurality of groups in accordance with the predetermined rule, the content catalog information transmitting means transmits the received updated-portion content catalog information to representative node devices belonging to the groups in accordance with destination information of the representative node devices belonging to the further divided groups, and
the content catalog information storing means stores the received updated-portion content catalog information.

3. The node device according to claim 2,
wherein version information indicative of a version is added to the updated-portion content catalog information, and
the node device further comprises:
version comparing means for comparing the version information added to the received updated-portion content catalog information with version information added to the content catalog information already stored; and
updating means, in the case where, as a result of comparison of the version comparing means, the version information added to the received updated-portion content catalog information is newer than the version information added to the already stored content catalog information by one, for updating the already stored content catalog information and its version information on the basis of the attribute information of the content data written in the received updated-portion content catalog information and its version information.

4. The node device according to claim 2,
wherein version information indicative of a version is added to the updated-portion content catalog information, and
the node device further comprises:
version comparing means for comparing the version information added to the received updated-portion content catalog information with version information added to the content catalog information already stored; and
updating means, in the case where, as a result of comparison of the version comparing means, the version information added to the received updated-portion content catalog information is newer than the version information added to the already stored content catalog information by two versions or more, for obtaining updated-portion content catalog information corresponding to version information to be positioned between both of the version information from the another node device, and for updating the already stored content catalog information and its version information on the basis of the obtained updated-portion content catalog information, the received updated-portion content catalog information and its version information.

5. The node device according to claim 2,
wherein version information indicative of a version is added to the updated-portion content catalog information, and
the node device further comprises:
version comparing means for comparing the version information added to the received updated-portion content catalog information with version information added to the content catalog information already stored,
wherein in the case where the version information added to the received updated-portion content catalog information is older than the version information added to the already stored content catalog information as a result of comparison of the version comparing means, the content catalog information transmitting means adds version information indicative of the new version to updated-portion content catalog information corresponding to a version newer than the version of the received updated-portion content catalog information, and transmits the resultant information to the another node device.

6. The node device according to claim 1, further comprising:
range information storing means for storing service range information indicative of a service range of the node device in content data which can be obtained in the information communication system and corresponds to the group to which the node device belongs; and
content specifying means for specifying content data in the service range indicated by the service range information, in the content data whose attribute information is written in the received content catalog information,
wherein the content catalog information storing means stores at least the content catalog information in which the attribute information of the specified content data is written.

7. The node device according to claim 6,
wherein content identification information as unique identification information made of a predetermined number of digits is associated with each of the content data which can be obtained in the information communication system,
node identification information as unique identification information made of the predetermined number of digits is associated with each of the node devices provided for the information communication system,
the service range information indicates the number of digits to be matched with node identification information of the node itself and the content identification information, as the number of digits which decreases as the service range is widened, and
the content specifying means specifies content data corresponding to the content identification information in which a predetermined digit of a predetermined number of digits to be matched which is indicated by the service range information matches the node identification information of the node itself, in content data whose attribute information is written in the received content catalog information.

8. The node device according to claim 6,
wherein a service range indicated by the service range information is set to be narrower as storage capacity of the content catalog information storing means is smaller.

9. The node device according to claim 6, further comprising:
service range changing means, when content catalog information in which attribute information of the specified content data is written is stored and then a data amount of content catalog information stored in the content catalog information storing means becomes equal to or larger than a predetermined amount, for changing a service range indicated by the service range information stored in the range information storing means so as to be narrowed; and
catalog information deleting means for deleting, from the content catalog information, attribute information of content data which lies out of the changed service range, in the content data whose attribute information is written in the content catalog information stored in the content catalog information storing means.

10. The node device according to claim 6,
wherein each time content catalog information stored in another node device is updated, attribute information of content data of an updated portion in the content catalog information is written in the content catalog information, the resultant information is transmitted as updated-portion content catalog information,
the content catalog information receiving means receives the updated-portion content catalog information transmitted from another node device,
in the case where the group to which the node device itself belongs is further divided in a plurality of groups in accordance with the predetermined rule, the content catalog information transmitting means transmits the received updated-portion content catalog information to representative node devices belonging to the groups in accordance with destination information of the representative node devices belonging to the further divided groups,
the content specifying means specifies content data in a service range indicated by the service range information, in content data whose attribute information is written in the received updated-portion content catalog information, and
the content catalog information storing means stores at least content catalog information in which attribute information of the specified content data is written.

11. The node device according to claim 10,
wherein version information indicative of a version is added to the updated-portion content catalog information, and
the content catalog information storing means stores version information added to the updated-portion content catalog information also in the case where even one piece of content data is not specified from content data whose attribute information is written in the received updated-portion content catalog information.

12. A recording medium in which a node process program for making a computer function as a node device of claim 1 is computer-readably recorded.

13. An information communication system having a plurality of node devices capable of performing communication with each other via a network, the plurality of node devices being divided in a plurality of groups according to a predetermined rule,
wherein the node device comprises:
destination information storing means for storing destination information of representative node devices belonging to the groups;
content catalog information receiving means for receiving content catalog information transmitted from another node device, the content catalog information being one in which attribute information of one or plural pieces of content data which can be obtained by the information communication system is written;
content catalog information transmitting means, in the case where the group to which the node device itself belongs is further divided in a plurality of groups in accordance with the predetermined rule, for transmitting the received content catalog information to the representative node devices belonging to the groups in accordance with destination information of the representative node devices belonging to the groups divided; and
content catalog information storing means for storing all or part of the received content catalog information.

14. A content catalog information distributing method in an information communication system having a plurality of node devices capable of performing communication with each other via a network, the plurality of node devices being divided in a plurality of groups according to a predetermined rule, comprising:
a process of receiving content catalog information transmitted from another node device by a node device, the content catalog information being one in which attribute information of content data which can be obtained by the information communication system is written;
a process, in the case where the group to which the node device itself belongs is further divided in a plurality of groups in accordance with the predetermined rule, of transmitting the received content catalog information by the node device to the representative node devices belonging to the groups in accordance with destination information of the representative node devices belonging to the groups divided; and
a process of storing all or part of the received content catalog information by the node device.
